(19) United States
(12) Patent Application Publication
(10) Pub. No.: US 2026/0362301 A1
(43) Pub. Date: Nov. 12, 2026

(54) METHOD AND APPARATUS FOR SERVICE RECOVERY IN WIRELESS COMMUNICATION

(71) Applicant: Samsung Electronics Co., Ltd., Gyeonggi-do (KR)

(72) Inventors: Utsav SINHA, Bangalore (IN); Lalith KUMAR, Bangalore (IN); Danish Ehsan HASHMI, Bangalore (IN); Govind UTTUR, Bangalore (IN); Vijay Kumar MISHRA, Bangalore (IN)

(21) Appl. No.: 19/122,919

(22) PCT Filed: Oct. 26, 2023
(86) PCT No.: PCT/KR2023/016777

§ 371 Date: Apr. 21, 2025

(30) Foreign Application Priority Data
Oct. 27, 2022 (IN) 202241061149
Nov. 4, 2022 (IN) 202241063174
Sep. 8, 2023 (IN) 202241061149
Sep. 8, 2023 (IN) 202342060592

(51) Int. Cl. H04W 48/18; H04W 48/02; H04W 60/00; H04W 84/10

(52) U.S. Cl. CPC H04W 48/18; H04W 48/02; H04W 60/001; H04W 84/10

(57) ABSTRACT

The disclosure relates to a 5th generation (5G) or 6th generation (6G) communication system for supporting a higher data transmission rate. A method performed by a user equipment (UE) in a wireless communication system is provided. The method includes selecting a stand-alone non-public network (SNPN), performing a registration on the selected SNPN, in case that the registration is rejected, adding the SNPN to a list of forbidden SNPNs, and in case that the SNPN is removed from the list of forbidden SNPNs and the UE is in a limited service state, performing an SNPN selection.

### TECHNICAL FIELD

The present disclosure relates to wireless communication systems, and more particularly, the disclosure relates to a method and an apparatus for a service recovery in a wireless communication system.

### BACKGROUND ART

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra eliable low latency communications (URLLC), and massive machine-type communications (mMTC), there has been ongoing standardization regarding beamforming and massive multiple-input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio user equipment (NR UE) power saving, non-terrestrial network (NTN) which is UE-satellite direct communication for providing coverage in an area in which communication with ter-restrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices, which have been exponentially increasing, will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the present disclosure. No determination has been made, and no assertion is made, as to whether any of the above might be applicable as prior art with regard to the disclosure.

### DISCLOSURE OF INVENTION

### Solution to Problem

The disclosure provides a method and an apparatus for a service recovery in a wireless communication system.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a sequence diagram illustrating a method for performing an efficient service recovery during a SNPN access mode in a wireless network;

FIG. 2 is a sequence diagram illustrating a method for performing an efficient service recovery during the SNPN access mode in the wireless network, according to the embodiments as disclosed herein;

FIG. 3 illustrates an exemplary environment in which the techniques of onboarding a User Equipment (UE) into a network may be implemented, in accordance with some embodiments of the present disclosure;

FIG. 4 shows various hardware components of the UE, according to the embodiments as disclosed herein;

FIG. 5 is a flow chart illustrating a method for the service recovery in the wireless network, according to the embodiments as disclosed herein;

FIG. 6A shows a sequence diagram for onboarding the UE into a network when the UE selects to operate in SNPN access operation mode, in accordance with some embodiments of the present disclosure;

FIG. 6B shows a sequence diagram for onboarding a UE into a network when the UE selects to not operate in SNPN access operation mode, in accordance with some embodiments of the present disclosure;

FIG. 7A shows a sequence diagram of a method for onboarding a UE into a network when the UE is operating in SNPN access operation mode.

FIG. 7B shows sequence diagram for onboarding a UE into a network when the UE is operating in SNPN access operation mode and has entered into a limited service state, in accordance with some embodiments of the present disclosure;

FIG. 8A shows a sequence diagram of a method for onboarding a UE into a network when the UE is not operating in SNPN access operation mode;

FIG. 8B shows a sequence diagram for onboarding a UE into a network when the UE is not operating in SNPN access operation mode and has entered into limited service state, in accordance with some embodiments of the present disclosure;

FIG. 9A shows a sequence diagram of a method for onboarding a UE into a network when the UE is operating in SNPN access operation mode;

FIG. 9B shows a sequence diagram for onboarding a UE into a network when the UE is operating in SNPN access operation mode and the UE is has entered into no service state, in accordance with some embodiments of the present disclosure;

FIG. 10A shows a sequence diagram of a method for onboarding a UE into a network when the UE is not operating in SNPN access operation mode.

FIG. 10B shows a sequence diagram for onboarding a UE into a network when the UE is not operating in SNPN access operation mode and the UE has entered into no service state, in accordance with some embodiments of the present disclosure.

FIG. 11 shows a flowchart illustrating a method for onboarding a UE into a network, in accordance with some embodiments of the present disclosure;

FIG. 12 shows a flowchart illustrating another method for onboarding a UE into a network, in accordance with some embodiments of the present disclosure;

FIG. 13 shows a flowchart illustrating another method for onboarding a UE into a network, in accordance with some embodiments of the present disclosure;

FIG. 14 shows a flowchart illustrating another method for onboarding a UE into a network, in accordance with some embodiments of the present disclosure;

FIG. 15 shows a flowchart illustrating another method for onboarding a UE into a network, in accordance with some embodiments of the present disclosure;

FIG. 16 is a diagram illustrating a UE according to an embodiment of the present disclosure; and

FIG. 17 is a diagram illustrating a base station according to an embodiment of the present disclosure.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

Throughout the drawings, it should be noted that like reference numbers are used to depict the same or similar elements, features, and structures.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Throughout the present disclosure, the expression “at least one of a, b or c” indicates only a, only b, only c, both a and b, both a and c, both b and c, all of a, b, and c, or variations thereof. Throughout the specification, a layer (or a layer apparatus) may also be referred to as an entity. Hereinafter, operation principles of the disclosure will be described in detail with reference to accompanying drawings. In the following descriptions, well-known functions or configurations are not described in detail because they would obscure the disclosure with unnecessary details. The terms used in the specification are defined in consideration of functions used in the disclosure, and can be changed according to the intent or commonly used methods of users or operators. Accordingly, definitions of the terms are understood based on the entire descriptions of the present specification.

For the same reasons, in the drawings, some elements may be exaggerated, omitted, or roughly illustrated. Also, a size of each element does not exactly correspond to an actual size of each element. In each drawing, elements that are the same or are in corre-spondence are rendered the same reference numeral.

Advantages and features of the present disclosure and methods of accomplishing the same may be understood more readily by reference to the following detailed descriptions of embodiments and accompanying drawings of the disclosure. The disclosure may, however, be embodied in many different forms and should not be construed as being limited to the embodiments set forth herein; rather, these embodiments of the disclosure are provided so that this disclosure will be thorough and complete, and will fully convey the concept of the disclosure to one of ordinary skill in the art. Therefore, the scope of the present disclosure is defined by the appended claims. Throughout the specification, like reference numerals refer to like elements. It will be understood that blocks in flowcharts or combinations of the flowcharts may be performed by computer program instructions. Because these computer program instructions may be loaded into a processor of a general-purpose computer, a special-purpose computer, or another programmable data processing apparatus, the instructions, which are performed by a processor of a computer or another programmable data processing apparatus, create units for performing functions described in the flowchart block(s).

The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufactured items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It is also noted that, in some alternative implementations, functions mentioned in blocks may occur out of order. For example, two consecutive blocks may also be executed simultaneously or in reverse order depending on functions corresponding thereto.

As used herein, the term “unit” denotes a software element or a hardware element such as a field-programmable gate array (FPGA) or an application-specific integrated circuit (ASIC), and performs a certain function. However, the term “unit” is not limited to software or hardware. The “unit” may be formed so as to be in an addressable storage medium, or may be formed so as to operate one or more processors. Thus, for example, the term “unit” may include elements (e.g., software elements, object-oriented software elements, class elements, and task elements), processes, functions, attributes, procedures, subroutines, segments of program code, drivers, firmware, micro-codes, circuits, data, a database, data structures, tables, arrays, or variables.

Functions provided by the elements and “units” may be combined into the smaller number of elements and “units,” or may be divided into additional elements and “units.” Furthermore, the elements and “units” may be embodied to reproduce one or more central processing units (CPUs) in a device or security multimedia card. Also, in an embodiment of the present disclosure, the “unit” may include at least one processor. In the following descriptions of the disclosure, well-known functions or configurations are not described in detail because they would obscure the disclosure with unnecessary details.

Hereinafter, for convenience of explanation, the present disclosure uses terms and names defined in the 3rd generation partnership project long term evolution (3GPP LTE) standards. However, the disclosure is not limited to the terms and names, and may also be applied to systems following other standards.

In the present disclosure, an evolved node B (eNB) may be interchangeably used with a next-generation node B (gNB) for convenience of explanation. That is, a base station (BS) described by an eNB may represent a gNB. In the following descriptions, the term “base station” refers to an entity for allocating resources to a user equipment (UE) and may be used interchangeably with at least one of a gNode B, an eNode B, a node B, a base station (BS), a radio access unit, a base station controller (BSC), or a node over a network. The term “terminal” may be used interchangeably with a UE, a mobile station (MS), a cellular phone, a smartphone, a computer, or a multimedia system capable of performing communication functions. However, the disclosure is not limited to the aforementioned examples. In particular, the disclosure is applicable to 3GPP new radio (NR) (or 5th generation (5G)) mobile communication standards. In the following description, the term eNB may be interchangeably used with the term gNB for convenience of explanation. That is, a base station explained as an eNB may also indicate a gNB. The term UE may also indicate a mobile phone, NB-IOT devices, sensors, and other wireless communication devices.

Generally, a User Equipment (UE) onboarding refers to provisioning of information or credentials to a UE required for the UE to get authorized access and connectivity to a Non-Public Network (NPN), for example, a Standalone Non-Public Network (SNPN). The onboarding of the UE may allow the UE to access an Onboarding Network (ONN) for the purpose of provisioning the UE with relevant credentials (e.g., SNPN credentials) to enable access to a desired network (e.g., SNPN) or to reselect or re-register with the desired network. In some configurations, the UE may be configured with default UE credentials. In such configurations, the UE may select the SNPN as the ONN and establish a secure connection with the selected SNPN (which is referred to as an Onboarding SNPN) to get provisioned with the SNPN credentials. In other configurations, the UE may be configured with Public Land Mobile Network (PLMN) credentials in Universal Subscriber Identity Module (USIM) and in such configurations, the UE may select the PLMN as the ONN and establish a secure connection with the selected PLMN to get provisioned with the SNPN credentials. Therefore, the UE may either use the SNPN or the PLMN as the onboarding network for onboarding services.

A UE may be configured to operate either in a SNPN access operation mode or to not operate in the SNPN access operation mode. Typically, a UE operating in the SNPN access operation mode is allowed to select and register only with the SNPN (and not with the PLMN) for the purpose of UE onboarding. However, sometimes the UE operating in the SNPN access operation mode may fail to register with a suitable SNPN e.g., when there are no onboarding SNPNs available in vicinity of the UE or when SNPNs are available but they are not suitable for performing onboarding (e.g., when the available SNPNs are present in forbidden SNPN list(s) for onboarding services of the UE). Thus, the UE operating in SNPN access operation mode may not be able to perform onboarding to get provisioned with the SNPN credentials to enable access to the SNPN. In such cases, even if PLMNs are available in the vicinity of the UE with which the UE may easily register to obtain the SNPN credentials, the existing techniques do not provide such mechanism for the UE to use the PLMNs for onboarding services. Instead, the UE may continue to search for suitable SNPNs which may provide onboarding services. Thus, there is a need to overcome such challenges and provide efficient techniques of onboarding a UE into a network.

Similarly, a UE which is not operating in the SNPN access operation mode is allowed to select and register only with the PLMN (and not with the SNPN) for the purpose of onboarding. However, sometimes the UE not operating in the SNPN access operation mode may fail to register with a suitable PLMN e.g., when there are no PLMNs available in vicinity of the UE or when PLMNs are available but they are not suitable for registration (e.g., when the available PLMNs are present in forbidden PLMN list(s) of the UE). In such cases, the UE may not be able to perform onboarding to get provisioned with the SNPN credentials to enable access to the SNPN. In such cases, even if SNPNs are available in the vicinity of the UE with which the UE may easily register to obtain the SNPN credentials, the existing techniques do not provide such mechanism for the UE to use the SNPNs for onboarding services. Instead, the UE may continue to search for suitable PLMNs. Thus, there is a need to overcome such challenges and provide efficient techniques of onboarding a UE into a network.

Further, 3^{rd} Generation Partnership Project (3GPP) specification requires a User Equipment (UE) to maintain a “temporarily forbidden Stand-alone Non-Public Network (SNPN)s” list, while operating in a SNPN access operation mode. The SNPN access operation mode is an existing definition from 3GPP TS 24.501. The UE operating in the SNPN access operation mode only selects SNPNs. This includes the case when the UE is accessing an SNPN over 3GPP access, the case when the UE is accessing an SNPN over non-3GPP access and the case where the UE is accessing SNPN services via a PLMN. An SNPN is added to a forbidden list, when the UE receives a registration reject, a service reject or a network (NW) initiated a de-registration request with a cause value #74 (i.e., Temporarily not authorized for the SNPN). As long as the SNPN is in the forbidden list, the UE in the SNPN access mode cannot select the SNPN for normal services. The UE is required to start an implementation specific timer, which is not shorter than 60 minutes when the SNPN is added to the forbidden list. The UE is required to start the timer when the reject message is integrity protected, and the UE is not configured to use a timer T3245. An SNPN entry is removed from the “temporarily forbidden SNPNs” list when the implementation specific timer expires. The UE in the SNPN access mode is allowed to select that SNPN henceforth, for the normal services to perform an efficient service recovery, when the UE in the SNPN access mode.

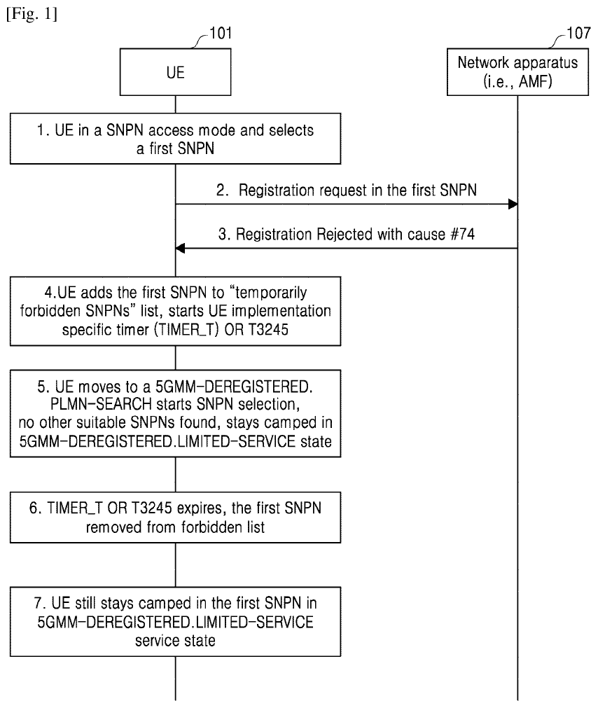

FIG. 1 is a sequence diagram illustrating a method for performing an efficient service recovery during the SNPN access mode in a wireless network.

At step 1, the UE (101) finds a suitable first SNPN, in an automatic selection mode. At step 2, a registration request exists in the first SNPN. At step 3, the registration is rejected with cause #74 at the UE (101). At step 4, the UE (101) adds the first SNPN in “temporarily forbidden SNPNs” list. The UE (101) is not configured to use T3245 when the UE (101) starts “UE implementation specific” timer. The UE (101) is configured to use T3245 when the UE (101) starts T3245 timer. At step 5, the UE (101) moves to a 5G Mobility Management (5GMM)-DEREGISTERED. PLMN-SEARCH to perform a SNPN selection. No other SNPNs are available in a current coverage area. The UE (101) camps for limited services in the first SNPN, and moves to 5GMM-DEREGISTERED.LIMITED-SERVICE state. At step 6, the UE implementation specific timer expires. The UE (101) removes the first SNPN from the “temporarily forbidden SNPNs” list. At step 7, the UE (101) still stays camped in the first SNPN in the 5GMM-DEREGISTERED. LIMITED-SERVICE state by using an Access and Mobility Management Function (AMF) entity (107) that performs registration management, connection management, reachability management, mobility management and various function relating to security and access management and authorization.

It is desired to address the above mentioned disadvantages or other short comings or at least provide a useful alternative.

A principal object of the embodiments herein is to provide a method and a UE for faster service recovery from a limited service state of the UE while the UE is camped in a SNPN in SNPN access operation mode.

Another object of the embodiments herein is to provide that the UE is in the limited service state. The UE triggers to remove a SNPN from a list upon detecting a T3245 expires or MS implementation specific timer expires. The SNPN is removed from either “temporarily forbidden SNPNs” or the “permanently forbidden SNPNs” list. The UE performs an immediate SNPN selection to find suitable SNPN for faster recovery of service in the wireless network.

Another object of the embodiments herein is to provide a method and the UE for performing an onboarding the UE into the wireless network.

Embodiments disclosed herein provide a method for service recovery in a wireless network. The method includes detecting, by a UE in the wireless network, expiry of a timer when the UE is in a limited service state. Further, the method includes removing, by the UE, a SNPN from a forbidden SNPN list when timer such as, but not limited to, MS implementation specific timer expiry, timer T3245 expiry is detected. Further, the method includes performing, by the UE, a SNPN selection with an AMF entity in the wireless network to obtain a normal service after removal of the SNPN from the forbidden SNPN list.

In an embodiment, the method includes camping, by the UE, in the SNPN based on the SNPN selection. Further, the method includes sending, by the UE, a registration request message in the SNPN to the AMF entity based on the SNPN selection. Further, the method includes receiving, by the UE, a registration accept message from the AMF entity to obtain the normal service.

In an embodiment, the timer is a T3245 timer. In another embodiment, the timer is a UE implementation specific timer. In another embodiment, the timer is a mobile station (MS) implementation specific timer.

In an embodiment, detecting expiry of the timer when the UE is in the limited service state includes detecting, by the UE, the SNPN when the UE is an SNPN access mode, sending, by the UE, a registration request message in the SNPN to the AMF entity based on the SNPN selection, receiving, by the UE, a registration reject message from the AMF entity, adding, by the UE, the SNPN to the forbidden SNPN list upon receiving the registration reject message from the AMF entity, starting, by the UE, the timer after adding the SNPN to the forbidden SNPN list, detecting, by the UE, whether any other SNPN is available in the wireless network, configuring, by the UE, into the limited service state when any other SNPN is not available in the wireless network, and detecting, by the UE, expiry of the timer when the UE is in the limited service state.

In an embodiment, the forbidden SNPN list is a permanently forbidden SNPN list. In another embodiment, the forbidden SNPN list is a temporary forbidden SNPN list.

Embodiments disclosed herein provide a UE for service recovery in a wireless network. The UE includes a service recovery controller communicatively coupled to a memory and a processor. The service recovery controller is configured to detect expiry of a timer when the UE is in a limited service state. Further, the service recovery controller is configured to remove a SNPN from a forbidden SNPN list when the expiry of the timer is detected. Further, the service recovery controller is configured to perform a SNPN selection with an AMF entity in the wireless network to gain normal services after removal of the SNPN from the forbidden SNPN list.

In an embodiment, the present disclosure discloses a method of onboarding a User Equipment (UE) into a network. The network may comprise one or more Standalone Non-Public Networks (SNPNs) and one or more Public Land Mobile Networks (PLMNs). The method comprising determining whether the UE is currently operating in a SNPN access operation mode or not operating in the SNPN access operation mode. The UE may be configured to operate in SNPN access operation mode and not to operate in the SNPN access operation mode. Further, the method comprises, in response to determining that the UE is operating in the SNPN access operation mode, selecting a SNPN, among the one or more SNPNs, which supports onboarding services for the UE. Furthermore, the method comprises, in response to determining that the UE is not operating in SNPN access operation mode, selecting a PLMN, among the one or more PLMNs available for registration of the UE and for configuration of SNPN subscription parameters via a user plane, in a PLMN. Thereafter, the method comprises successfully registering the UE with the selected network for establishing a secure connection between the UE and the selected network. The selected network comprises one of the SNPN or the PLMN. Finally, the method comprises performing onboarding of the UE into the selected network by obtaining UE onboarding data using the secure connection.

In an embodiment, the present disclosure discloses a method of onboarding a User Equipment (UE) into a network. The network may comprise one or more Standalone Non-Public Networks (SNPNs) and one or more Public Land Mobile Networks (PLMNs). The method comprising determining whether the UE is currently operating in a SNPN access operation mode or not operating in the SNPN access operation mode. The UE may be configured to operate in the SNPN access operation mode and not to operate in the SNPN access operation mode. Further, the method comprising, in response to determining that the UE is operating in the SNPN access operation mode, selecting a SNPN, among the one or more SNPNs, which supports onboarding services for the UE. Further, the method comprising receiving a registration failure while establishing a secure connection between the UE and the selected SNPN. Furthermore, the method comprising, in response to receiving the registration failure, determining whether any other SNPN among the one or more SNPNs supports the onboarding services of the UE. Thereafter, the method comprising, upon determining that no other SNPN among the one or more SNPNs supports the onboarding services of the UE, switching access operation mode of the UE by deactivating the SNPN access operation mode. Finally, the method comprising selecting a PLMN, among the one or more PLMNs, available to the UE for configuration of SNPN subscription parameters using a user plane of the selected PLMN.

In an embodiment, the present disclosure discloses a method of onboarding a User Equipment (UE) into a network. The network may comprise one or more Standalone Non-Public Networks (SNPNs) and one or more Public Land Mobile Networks (PLMNs). The method comprising determining whether the UE is currently operating in a SNPN access operation mode or not operating in the SNPN access operation mode. The UE may be configured to operate in the SNPN access operation mode and not to operate in the SNPN access operation mode. Further, the method comprising, in response to determining that the UE is not operating in the SNPN access operation mode, selecting a PLMN, among the one or more PLMNs, available to the UE for registration and for configuration of SNPN subscription parameters via user plane of the selected PLMN. Further, the method comprising receiving registration failure while establishing a secure connection between the UE and the selected PLMN. Furthermore, the method comprising, in response to receiving the registration failure, determining whether any other PLMN is available to the UE for registration and for configuration of SNPN subscription parameters via the user plane of the PLMN. Thereafter, the method comprising, upon determining that no other PLMN is available for registration of the UE, switching access operation mode of the UE by activating the SNPN access operation mode. Finally, the method comprising selecting a SNPN, among the one or more SNPNs, which supports onboarding services for the UE and performing the onboarding of the UE into the network using the selected SNPN.

In an embodiment, the present disclosure discloses a method of onboarding a User Equipment (UE) into a network. The network may comprise one or more Standalone Non-Public Networks (SNPNs) and one or more Public Land Mobile Networks (PLMNs). The method comprising determining whether the UE is currently operating in a SNPN access operation mode or not operating in the SNPN access operation mode. The UE may be configured to operate in the SNPN access operation mode and not to operate in the SNPN access operation mode. Further, the method comprising, in response to determining that the UE is operating in the SNPN access operation mode, identifying whether a SNPN, among the one or more SNPNs, that supports onboarding services for the UE is currently available or not. Thereafter, the method comprising, switching access operation mode of the UE by deactivating the SNPN access operation mode upon identifying that no SNPN, among the one or more SNPNs, is currently available that supports the onboarding services for the UE. Finally, selecting a PLMN, among the one or more PLMNs, available for registration of the UE and for configuration of SNPN subscription parameters using user plane of the selected PLMN.

In an embodiment, the present disclosure discloses a method of onboarding a User Equipment (UE) into a network. The network may comprise one or more Standalone Non-Public Networks (SNPNs) and one or more Public Land Mobile Networks (PLMNs). The method comprising determining whether the UE is currently operating in a SNPN access operation mode or not operating in the SNPN access operation mode. The UE may be configured to operate in the SNPN access operation mode ant not to operate in the SNPN access operation mode. Further, the method comprising, in response to determining that the UE is not operating in the SNPN access operation mode, identifying whether a PLMN, among the one or more PLMNs, is available to the UE for registration, and for configuration of SNPN subscription parameters via a user plane of the PLMN. Thereafter, the method comprising, switching access operation mode of the UE by activating the SNPN access operation mode upon identifying that no PLMN, among the one or more PLMNs, is currently available for registration of the UE and for configuration of SNPN subscription parameters via the user plane of the PLMN. Finally, the method comprising selecting a SNPN, among the one or more SNPNs, which supports the onboarding services for the UE and performing the onboarding of the UE into the network using the selected SNPN.

In an embodiment, the present disclosure discloses an apparatus for onboarding a User Equipment (UE) into a network which comprises one or more Standalone Non-Public Networks (SNPNs) and one or more Public Land Mobile Networks (PLMNs). The apparatus comprises a memory and a processor. The processor is configured to determine whether the UE is currently operating in a SNPN access operation mode and not operating in the SNPN access operation mode. The UE is configured to operate in the SNPN access operation mode or not operate in the SNPN access operation mode. Further, the processor is configured to, in response to determining that the UE is operating in the SNPN access operation mode, select a SNPN, among the one or more SNPNs, which supports onboarding services for the UE. Furthermore, the processor is configured to, in response to determining that the UE is not operating in the SNPN access operation mode, select a PLMN, among the one or more PLMNs, for registration of the UE and for configuration of SNPN subscription parameters via a user plane in PLMN. Thereafter, the processor is configured to successfully register the UE with a selected network for establishing a secure connection between the UE and the selected network. The selected network may comprise one of the SNPN or the PLMN. Finally, the processor is configured to perform onboarding of the UE into the selected network by obtaining UE onboarding data using the secure connection.

In an embodiment, the present disclosure discloses an apparatus for onboarding a User Equipment (UE) into a network which comprises one or more Standalone Non-Public Networks (SNPNs) and one or more Public Land Mobile Networks (PLMNs). The apparatus comprises a memory and a processor. The processor is configured to determine whether the UE is currently operating in a SNPN access operation mode or not operating in the SNPN access operation mode. The UE is configured to operate in the SNPN access operation mode or not operate in the SNPN access operation mode. Further, the processor is configured to, in response to determining that the UE is operating in the SNPN access operation mode, select a SNPN, among the one or more SNPNs, which supports onboarding services for the UE. Further, the processor is configured to receive a registration failure while establishing a secure connection between the UE and the selected SNPN. Furthermore, the processor is configured to, in response to receiving the registration failure, determine whether any other SNPN among the one or more SNPNs support the onboarding services for the UE. Thereafter, the processor is configured to, upon determining that no other SNPN among the one or more SNPNs supports the onboarding services for the UE, switch access operation mode of the UE by deactivating SNPN access operation mode. Finally, the processor is configured to select a PLMN, among the one or more PLMNs, available to the UE for registration and for configuration of SNPN subscription parameters using a user plane of the selected PLMN.

In an embodiment, the present disclosure discloses an apparatus for onboarding a User Equipment (UE) into a network which comprises one or more Standalone Non-Public Networks (SNPNs) and one or more Public Land Mobile Networks (PLMNs).

The apparatus comprises a memory and a processor. The processor is configured to determine whether the UE is currently operating in a SNPN access operation mode and not operating in the SNPN access operation mode. The UE is configured to operate in the SNPN access operation mode or not operate in the SNPN access operation mode. Further, the processor is configured to, in response to determining that the UE is not the operating in SNPN access operation mode, select a PLMN, among the one or more PLMNs, available for the registration of the UE and for configuration of SNPN subscription parameters via a user plane of the selected PLMN. Further, the processor is configured to receive a registration failure while establishing a secure connection between the UE and the selected PLMN. Furthermore, the processor is configured to, in response to receiving the registration failure, determine whether any other PLMN is available to the UE for registration and for configuration of SNPN subscription parameters via the user plane of the PLMN. Thereafter, the processor is configured to, upon determining that no other PLMN is available for registration of the UE, switch access operation mode of the UE by activating SNPN access operation mode. Finally, the processor is configured to select a SNPN, among the one or more SNPNs, which supports onboarding services for the UE and perform the onboarding of the UE into the network using the selected SNPN.

In an embodiment, the present disclosure discloses an apparatus for onboarding a User Equipment (UE) into a network which comprises one or more Standalone Non-Public Networks (SNPNs) and one or more Public Land Mobile Networks (PLMNs). The apparatus comprises a memory and a processor. The processor is configured to determine whether the UE is currently operating in a SNPN access operation mode and not operating in SNPN access operation mode. The UE is configured to operate in the SNPN access operation mode or not operate in the SNPN access operation mode.

Further, the processor is configured to, in response to determining that the UE is operating in the SNPN access operation mode, identify whether a SNPN, among the one or more SNPNs, that supports onboarding services for the UE is currently available or not. Thereafter, the processor is configured to switch access operation mode of the UE by deactivating SNPN access operation mode upon identifying that no SNPN, among the one or more SNPNs, is currently available that supports the onboarding services for the UE. Finally, the processor is configured to select a PLMN, among the one or more PLMNs, available for registration of the UE and for configuration of SNPN subscription parameters using user plane of the selected PLMN.

In an embodiment, the present disclosure discloses an apparatus for onboarding a User Equipment (UE) into a network which comprises one or more Standalone Non-Public Networks (SNPNs) and one or more Public Land Mobile Networks (PLMNs). The apparatus comprises a memory and a processor. The processor is configured to determine whether the UE is currently operating in a SNPN access operation mode and not operating in the SNPN access operation mode. The UE is configured to operate in access operation mode or not operate in the SNPN access operation mode. Further, the processor is configured to, in response to determining that the UE is not operating in the SNPN access operation mode, identify whether a PLMN, among the one or more PLMNs, is available to the UE for registration, and for configuration of SNPN subscription parameters via user plane of the PLMN. Thereafter, the processor is configured to switch access operation mode of the UE by activating SNPN access operation mode upon identifying that no PLMN, among the one or more PLMNs, is currently available for registration of the UE and for configuration of SNPN subscription parameters via user plane of the PLMN. Finally, the processor is configured to select a SNPN, among the one or more SNPNs, which supports the onboarding services for the UE and perform the onboarding of the UE into the network using the selected SNPN.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

Embodiments herein disclose a method for service recovery in a wireless network. The method includes detecting, by a UE in the wireless network, expiry of a timer when the UE is in a limited service state. Further, the method includes removing, by the UE, a SNPN from a forbidden SNPN list when the expiry of the timer is detected. Further, the method includes performing, by the UE, an immediate SNPN selection with an AMF entity in the wireless network to obtain a normal service after removal of the SNPN from the forbidden SNPN list.

The method can be used to perform an efficient service recovery in SNPN access mode. The method can be used to perform immediate SNPN selection or cell selection or cell reselection and retries/attempts registration procedure (initial registration or mobility or periodic registration) to regain normal services, in an SNPN being removed from “temporarily forbidden SNPNs” list or “permanently forbidden SNPNs” list, while still in 5G Mobility Management (5GMM)-DEREGISTERED.LIMITED-SERVICE state or 5GMM-REGISTERED.LIMITED-SERVICE state or one of the 5GMM sublayer states.

The proposed method is applicable for “permanently forbidden SNPNs” same as “temporarily forbidden SNPNs”. The term 5GMM-DEREGISTERED.LIMITED-SERVICE state or 5GMM-REGISTERED.LIMITED-SERVICE state and limited service state are used interchangeably and have same meaning. The proposed method also performs UE initiated service request procedure and the network initiated de-registration procedure same as registration procedure in the embodiment disclosed in the patent application.

In an embodiment, if the SNPN is being removed from the “temporarily forbidden SNPNs” or the “permanently forbidden SNPNs” list (e.g., due to MS implementation specific timer not shorter than 60 minutes expires or timer T3245 expires), and the MS is in the limited service state, and the MS does not have a Protocol Data Unit (PDU) session for emergency services, the MS performs SNPN selection based on the automatic SNPN selection mode procedure (as described in subclause 4.9.3.1 of the 3GPP). If the MS has an established emergency PDU session, then the UE attempts to perform the SNPN selection subsequently after the emergency PDU session is released.

The present disclosure overcomes some or all of the above-mentioned problems by dynamically switching between SNPN access operation modes so that a UE (configured with both default UE credentials and PLMN credentials from USIM) may be able to continue with onboarding in cases where the UE cannot proceed with onboarding procedure using current operation mode of the UE. Particularly, the present disclosure proposes switching operation from operating in the SNPN access operation mode to not operating in the SNPN access operation and/or vice-versa in order to onboard the UE into a network.

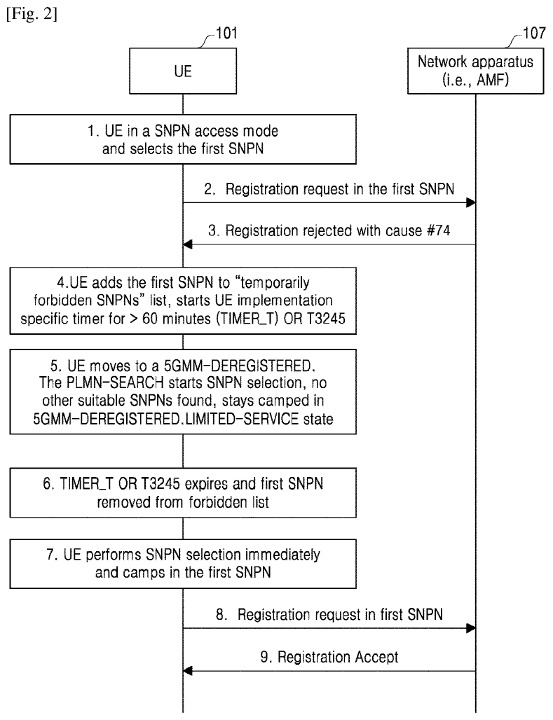

Referring now to the drawings, and more particularly to FIGS. 2-6B, FIG. 7B, FIG. 8B, FIG. 9B, FIG. 10B, and FIG. 11-F igure 17, there are shown preferred embodiments.

FIG. 2 is a sequence diagram illustrating a method for performing an efficient service recovery during a SNPN access mode in a wireless network, according to the embodiments as disclosed herein. The wireless network can be, for example, but not limited to a fourth generation (4G) network, a fifth generation (5G) network, an Open Radio Access Network (ORAN), a sixth generation (6G) network. In an embodiment, the wireless network includes the UE (101) and the AMF (107).

The UE (101) can be, for example, but not limited to a laptop, a smart phone, a desktop computer, a notebook, a Device-to-Device (D2D) device, a vehicle to ev-erything (V2X) device, a foldable phone, a smart TV, a tablet, an immersive device, and an internet of things (IoT) device.

Referring to FIG. 2, the method performs the efficient service recovery in the SNPN access mode in two scenarios explained below. Referring to FIG. 2, a first scenario shows the UE (101) operating in a SNPN access operation mode. At step 1, the UE (101) finds a suitable first SNPN, in SNPN selection mode. At step 2, a registration request exists in the first SNPN. At step 3, the registration is rejected with cause #74 at the UE (101). At step 4, the UE (101) adds the first SNPN in a “temporarily forbidden SNPNs” list. The UE (101) is not configured to use T3245. The UE (101) is required to start a UE implementation specific timer, which is not shorter than 60 minutes. At step 5, the UE (101) moves to a 5GMM-DEREGISTERED.PLMN-SEARCH and performs the SNPN selection. No other SNPNs are available in a current coverage area. The UE (101) camps for limited services in the first SNPN and moves to a 5G Mobility Management (5GMM)-DEREGISTERED.LIMITED-SERVICE state. At step 6, the UE implementation specific timer expires and the UE (101) removes the first SNPN from the “temporarily forbidden SNPNs” list or when “temporarily forbidden SNPNs” list is deleted. At step 7, the UE (101) performs immediate SNPN selection or cell selection or cell reselection and retries/attempts registration procedure (initial registration or mobility or periodic registration) to regain normal services in the 5GMM-DEREGISTERED.LIMITED-SERVICE state or the 5GMM-REGISTERED.LIMITED-SERVICE state or one of the 5GMM sublayer states. At step 8, the UE (101) sends a registration request in the first SNPN. At step 9, the registration is accepted by using an AMF (107) (i.e., AMF entity) that performs registration management, connection management, reachability management, mobility management and various function relating to security and access management and authorization.

The second scenario shows the UE (101) operating in the SNPN access operation mode. At step 1, the UE (101) finds the suitable first SNPN in SNPN selection mode. At step 2, the registration request exists in the first SNPN. At step 3, the registration is rejected with the cause #74 at the UE (101). At step 4, the UE (101) adds the first SNPN in the “temporarily forbidden SNPNs” list. At step 5, the UE (101) is configured to use T3245. The UE (101) is required to start the T3245 timer. The UE (101) moves to the 5GMM-DEREGISTERED.PLMN-SEARCH and performs the SNPN selection. No other SNPNs are available in the current coverage area. The UE (101) camps for the limited services in the first SNPN and moves to the 5GMM-DEREGISTERED.LIMITED-SERVICE state. At step 6, the T3245 timer expires. The UE (101) removes the first SNPN from the “temporarily forbidden SNPNs” list or when “temporarily forbidden SNPNs” list is deleted. At step 7, the UE (101) performs the immediate SNPN selection or the cell selection or the cell reselection and retries/attempts the registration procedure (initial registration or mobility or periodic registration) to regain the normal services in the 5GMM-DEREGISTERED.LIMITED-SERVICE state or the 5GMM-REGISTERED.LIMITED-SERVICE state or one of the 5GMM sublayer states registration procedure (initial registration or mobility or periodic registration) to regain normal services. At step 8, the UE (101) sends the registration request in the first SNPN. At step 9, finally, the registration is accepted by using the AMF (107) that performs registration management, connection management, reachability management, mobility management and various function relating to security and access management and authorization.

The proposed method is applicable for “permanently forbidden SNPNs” same as “temporarily forbidden SNPNs”, when UE (101) receives 5GMM reject cause #75 “permanently not authorized for this SNPN”. The term 5GMM-DEREGISTERED.LIMITED-SERVICE state or 5GMM-REGISTERED.LIMITED-SERVICE state and limited service state are used interchangeably and have same meaning. The proposed method also performs UE initiated service request procedure and a network initiated de-registration procedure same as registration procedure in the embodiment. The term 5GMM substate in the embodiment is at least one of the below:
1) 5GMM-NULL,
2) 5GMM-DEREGISTERED,
a) 5GMM-DEREGISTERED.NORMAL-SERVICE,
b) 5GMM-DEREGISTERED.LIMITED-SERVICE,
c) 5GMM-DEREGISTERED.ATTEMPTING-REGISTRATION,
d) 5GMM-DEREGISTERED.PLMN-SEARCH,
e) 5GMM-DEREGISTERED.NO-SUPI,
f) 5GMM-DEREGISTERED.NO-CELL-AVAILABLE,
g) 5GMM-DEREGISTERED.eCALL-INACTIVE,
h) 5GMM-DEREGISTERED.INITIAL-REGISTRATION-NEEDED,
3) 5GMM-REGISTERED-INITIATED,
4) 5GMM-REGISTERED,
a) 5GMM-REGISTERED.NORMAL-SERVICE,
b) 5GMM-REGISTERED.NON-ALLOWED-SERVICE,
c) 5GMM-REGISTERED.ATTEMPTING-REGISTRATION-UPDATE,
d) 5GMM-REGISTERED.LIMITED-SERVICE,
e) 5GMM-REGISTERED.PLMN-SEARCH,
f) 5GMM-REGISTERED.NO-CELL-AVAILABLE,
g) 5GMM-REGISTERED.UPDATE-NEEDED,
5) 5GMM-DEREGISTERED-INITIATED, and
6) 5GMM-SERVICE-REQUEST-INITIATED.

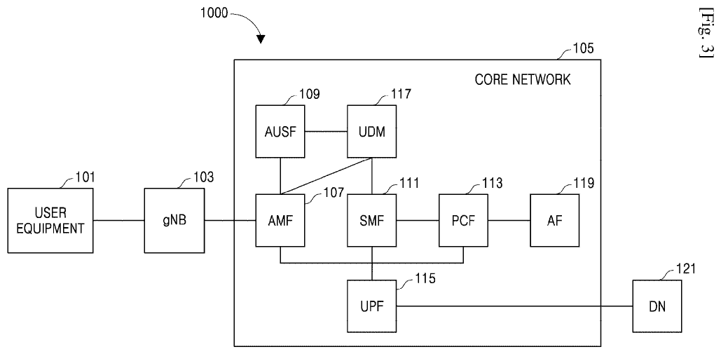

FIG. 3 illustrates an exemplary environment or communication network (1000) in which the techniques of onboarding a UE (101) into a network may be implemented, in accordance with some embodiments of the present disclosure. As illustrated in FIG. 3, the exemplary communication network (1000) may comprise a UE (101), a Next Generation (e.g., 5G) base station (gNodeB or gNB) (103), and a core network (105).

In an embodiment, the UE (101) may be configured to communicate with the core network (105) via the gNB (103). The UE (101) may include, without limitation, a smart phone, a tablet, a desktop, a laptop, a smart watch and the like. The UE (101) may be configured to operate in a Standalone Non-Public Network (SNPN) access operation mode and not to operate in the SNPN access operation mode. If the UE (101) selects to operate in the SNPN access operation mode, then the UE (101) may be allowed only to select and register in a SNPN and if the UE (101) selects to not operate in the SNPN access operation mode, then the UE (101) may be allowed only to select and register in a Public Land Mobile Network (PLMN). The gNB (103) may be a 3GPP 5G next generation base station which may support 5G New Radio (NR). In other words, the gNB (103) may be a node in a cellular network which may provide connectivity between the UE (101) and the core network (105).

The core network (105) may be network that controls data and control plane operations. The core network (105) may aggregate data traffic, communicate with the UE (101), deliver essential network services, and provide extra layers of security among other functions. In one embodiment, the core network (105) may be an SNPN or a PLMN. The core network (105) may include without limitation, an Access and Mobility Management Function (AMF) (107), an Authentication Server Function (AUSF) (109), a Session management Function (SMF) (111), a Policy control function (PCF) (113), an User Plane Function (UPF) (115), an Unified Data Management (UDM) (117), an Application Function (AF) (119), but not limited thereto. The core network (105) may be connected to data network (DN) or internet (121). In one embodiment, the core network (105) may be a 5G core network.

The AMF (107) may be a control plane function in the core network (105). The AMF (107) may allow the UE (101) to register or de-register with the core network (105). That is, the UE (101) may complete the registration procedure to receive authorization to use 5G services. The AMF (107) may establish and release control plane signalling connection between the UE (101) and the AMF (107). The AUSF (109) may be responsible for verifying an identity of a subscriber, validating their subscription data, and determining an appropriate security context for the subscriber. The primary function of the AUSF (109) may be supporting of authentication and authorization procedures. For example, when the subscriber attempts to connect to a 5G network, the AUSF (109) may verify subscriber's identity and may ensure that the subscriber has proper authorization to access the 5G network.

The SMF (111) may be responsible for interacting with decoupled data plane, creating, updating and removing Protocol Data Unit (PDU) session, and managing session. The PCF (113) may support unified policy framework which may govern network behaviour. The UPF (115) helps in process of data transfer. The UPF (115) may provide an interconnect point between mobile infrastructure and the DN (121).

The UDM (117) of the core network (105) is a control plane function. The UDM (117) may manage data for access authorization, user registration, and data network profiles. The UDM (117) may provide subscription management, and storage and management of Subscription Permanent Identifier (SUPI) for each subscriber in the 5G network. The AF (119) may be a control plane function in the core network (105) and may provide application services to the subscriber. The DN (121) may identify service provider services, and internet access or 3^{rd} party services.

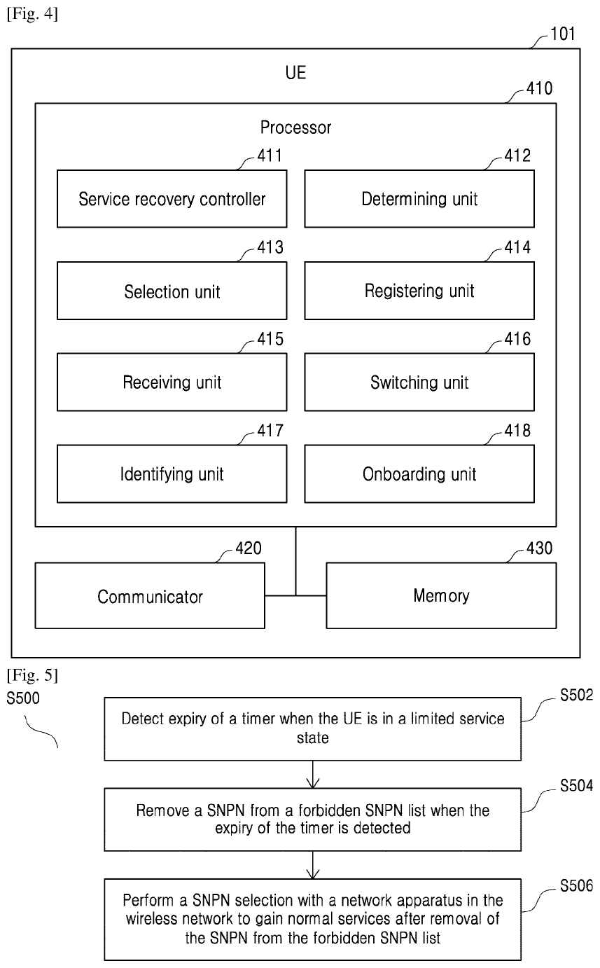

FIG. 4 shows various hardware components of the UE (101), according to the embodiments as disclosed herein. In an embodiment, the UE (101) includes a processor (410) (e.g., Central Processing Unit (CPU) or the like), a communicator (420), a memory (430), and an input/output (I/O) interface (not shown). The processor (410) is coupled with the communicator (420), the memory (430) and the I/O interface.

In some embodiments, the memory (430) may be communicatively coupled to the one or more processors (430). The memory (430) stores instructions executable by the one or more processors (430). The one or more processors (430) may comprise at least one data processor for executing program components for executing user or system-generated requests. The memory (430) may store instructions, executable by the one or more processors (430), which on execution, may cause the one or more processors (430) to onboard the UE (101) into a network 105. The I/O interface 203 may be coupled with the one or more processors (430) through which an input signal and/or an output signal may be communicated. For example, the one or more processors (430) may communicate with the core network (105) as shown in FIG. 1.

In an embodiment, the one or more processor (410) may include one or more modules or units, for e.g., a determining unit (412), a selection unit (413), a registering unit (414), a receiving unit (415), a switching unit (416), an identifying unit (417), and an onboarding unit (418), but not limited thereto. In some embodiments, the one or more modules or units may be software modules which may be stored in the memory (430). The one or more modules may be configured to perform the various operations of the present disclosure to enable onboarding of the UE (101) into the network.

The service recovery controller (411) detects expiry of the timer when the UE (101) is in the limited service state. The timer is one of the T3245 timer, the UE implementation specific timer, and the MS implementation specific timer. In an embodiment, the forbidden SNPN list is the permanently forbidden SNPN list. In another embodiment, the forbidden SNPN list is the temporary forbidden SNPN list.

In an embodiment, the service recovery controller (411) detects the SNPN when the UE (101) is in the SNPN access operation mode. Based on the SNPN selection, the service recovery controller (411) sends the registration request message in the SNPN to the AMF (107). Further, the service recovery controller (411) receives the registration reject message from the AMF (107). Further, the service recovery controller (411) adds the SNPN to the forbidden SNPN list upon receiving the registration reject message from the AMF (107). After adding the SNPN to the forbidden SNPN list, the service recovery controller (411) start the timer. Further, the service recovery controller (411) detects whether any other SNPN is available in the wireless network (1000). Further, the service recovery controller (411) configures into the limited service state when any other SNPN is not available in the wireless network (1000). Further, the service recovery controller (411) detect expiry of the timer when the UE (101) is in the limited service state.

Further, the service recovery controller (411) removes the SNPN from the forbidden SNPN list when the expiry of the timer is detected. Further, the service recovery controller (411) performs the SNPN selection with the AMF (107) to gain the normal service after removal of the SNPN from the forbidden SNPN list.

Further, the service recovery controller (411) camps in the SNPN based on the SNPN selection. Further, the service recovery controller (411) sends the registration request message in the SNPN to the AMF (107) based on the SNPN selection. Further, the service recovery controller (411) receives a registration accept message from the AMF (107).

The service recovery controller (411) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (410) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (410) may include multiple cores and is configured to execute the instructions stored in the memory (430).

Further, the processor (410) is configured to execute instructions stored in the memory (430) and to perform various processes. The communicator (420) is configured for communicating internally between internal hardware components and with external devices via one or more networks. The memory (430) also stores instructions to be executed by the processor (410). The memory (430) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (430) may, in some examples, be considered a non-transitory storage medium. The term “non-transitory” may indicate that the storage medium is not embodied in a carrier wave or a propagated signal. However, the term “non-transitory” should not be interpreted that the memory (430) is non-movable. In certain examples, a non-transitory storage medium may store data that can, over time, change (e.g., in Random Access Memory (RAM) or cache).

Although the FIG. 4 shows various hardware components of the UE (101) but it is to be understood that other embodiments are not limited thereon. In other embodiments, the UE (101) may include less or more number of components. Further, the labels or names of the components are used only for illustrative purpose and does not limit the scope of the invention. One or more components can be combined together to perform same or substantially similar function in the UE (101).

FIG. 5 is a flow chart (S500) illustrating a method for the service recovery in the wireless network (1000), according to the embodiments as disclosed herein. The operations (S502-S506) may be handled by the service recovery controller (411).

At S502, the method includes detecting the expiry of the timer when the UE (101) is in the limited service state. At S504, the method includes removing the SNPN from the forbidden SNPN list when the expiry of the timer is detected. At S506, the method includes perform the SNPN selection with the AMF (107) in the wireless network (1000) to gain the normal service after removal of the SNPN from the forbidden SNPN list.

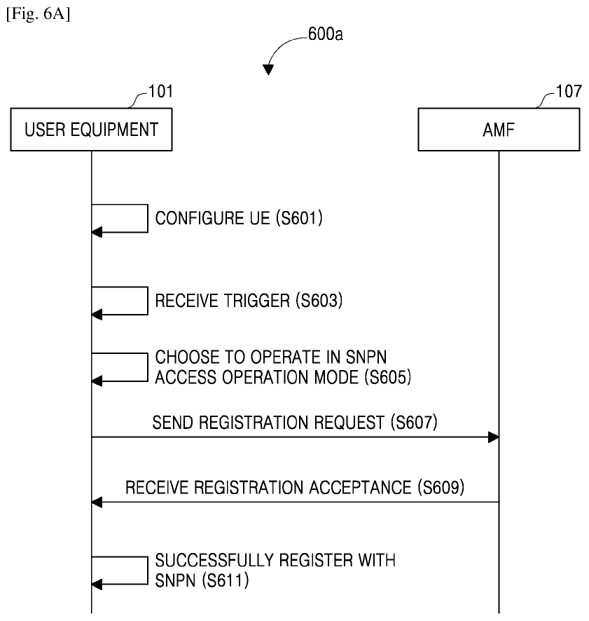

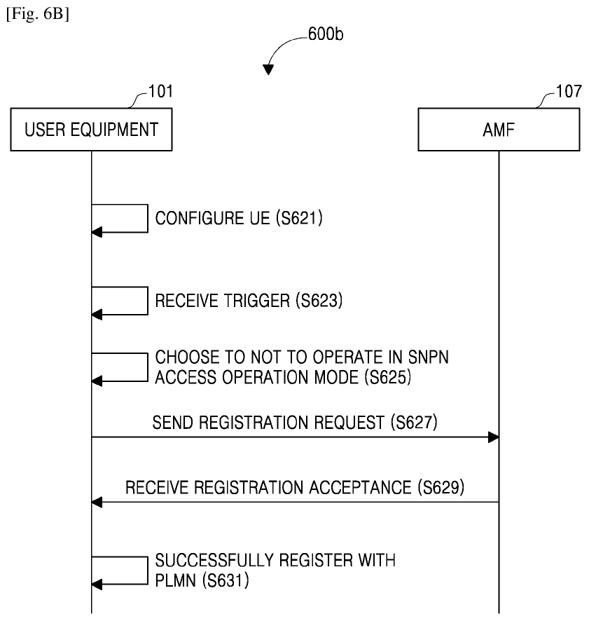

FIG. 6A shows a sequence diagram 600a for onboarding a UE (101) into a network when the UE (101) selects to operate in a SNPN access operation mode, in accordance with some embodiments of the present disclosure.

Initially, the UE (101) may communicate with an AMF (107) associated with the core network (105). At S601, the UE (101) may be configured with default UE credentials and PLMN credentials. The PLMN credentials may be provisioned in a Universal Subscriber Identity Module (USIM) of the UE (101). At S603, the UE (101) may receive a trigger to perform onboarding into the core network (105). For instance, the trigger for the UE (101) to initiate the UE onboarding procedure is UE implementation dependent. For example, the trigger for the UE (101) may be a power-on event of the UE (101) or an input from a user.

At S605, as an option, the UE (101) may select or choose to operate in the SNPN access operation mode or not to operate in the SNPN access operation mode. For example, the UE (101) may select to operate in the SNPN access operation mode. As a result, the UE (101) may perform SNPN selection and identify a suitable SNPN among one or more SNPNs which may support onboarding services for the UE (101).

At S607, upon identifying the SNPN which supports the onboarding services for the UE (101), the UE (101) may send a registration request to the AMF (107) associated with the SNPN to establish a secure connection between the UE (101) and the selected SNPN for registering the UE (101) with the selected SNPN. At S609, the AMF (107) may accept the UE registration request and send a notification or response (i.e., acceptance of the registration request) to the UE (101). At S611, the UE (101) successfully registers with the SNPN that supports onboarding services for the UE (101) and establishes the secure connection between the UE (101) and the selected SNPN. Subsequently, the UE (101) may perform onboarding into the selected SNPN by obtaining UE onboarding data using the established secure connection. As an example, the UE onboarding data may include, without limitation, SNPN subscription parameters or SNPN subscription related data.

FIG. 6B shows a sequence diagram 600b for onboarding a UE (101) into a core network (105) when the UE (101) selects to not operate in SNPN access operation mode, in accordance with some embodiments of the present disclosure.

Initially, the UE (101) may communicate with an AMF (107) associated with the core network (105). The operations of S621 and S623 may be similar to the respective operations of S601 and S603 of the FIG. 6A. After receiving the trigger to perform onboarding into the core network (105), at S625, the UE (101) may select to not operate in the SNPN access operation mode. As a result, the UE (101) may identify and select a PLMN among one or more PLMNs available to the UE (101) for registration and for configuration of SNPN subscription parameters via a user plane of the PLMN. Typically, a UE may register in any PLMN where the registration is allowed. After registration, the UE may setup a Protocol Data Unit (PDU) session for establishing a secure connection. During the PDU session establishment procedure, the SMF (111) may provide PVS addresses. The PVS addresses are used by the UE (101) to obtain the SNPN credentials. This is referred to as configuration of SNPN credentials via the user plane of the PLMN.

At S627, upon identifying the PLMN which supports the registration services for the UE (101), the UE (101) may send a registration request to the AMF (107) to establish a secure connection between the UE (101) and the selected PLMN, for registering the UE (101) with the selected PLMN. At S629, the AMF (107) may accept the UE registration request and send a notification or response (i.e., acceptance of the registration request) to the UE (101). At S631, the UE (101) successfully registers with PLMN that supports registration services for the UE (101) and establishes a secure connection between the UE (101) and the selected PLMN. Subsequently, the UE onboarding into the selected PLMN is performed by obtaining UE onboarding data using the secured connection. As an example, the UE onboarding data may include, without limitation, SNPN subscription parameters or SNPN subscription related data.

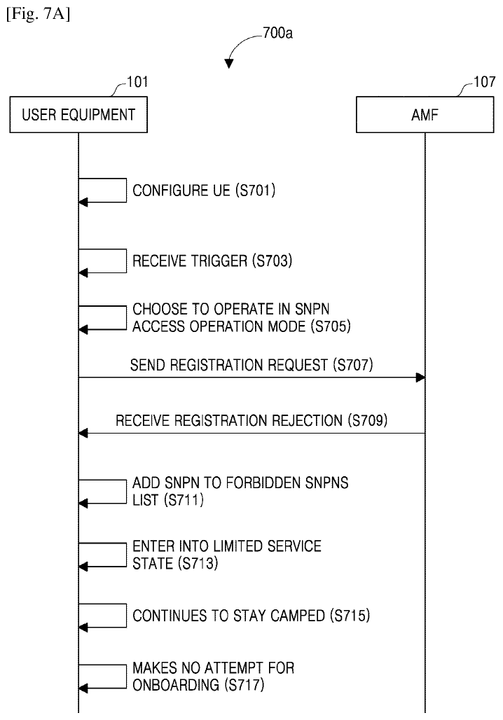

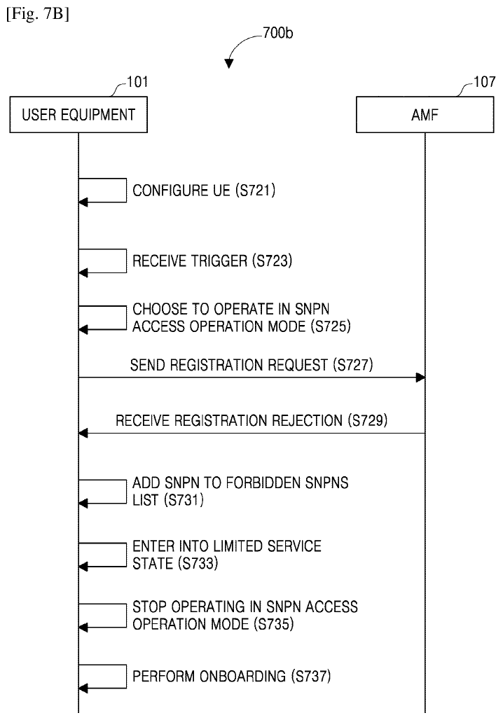

FIG. 7A shows a sequence diagram 700a of a method for onboarding the UE (101) into the core network (105) when the UE (101) is operating in the SNPN access operation mode.

Initially, the UE (101) may communicate with an AMF (107) associated with the core network (105). The UE (101) may choose to operate in the SNPN access operation mode in steps S701 to S705 and may identify a suitable SNPN among one or more SNPNs which may support onboarding services for the UE (101). The process of selection of SNPN as described in steps S701 to S705 may be similar to the process described in the steps S601 to S605 of the FIG. 6A and the same is not repeated for the sake of brevity.

At S707, upon identifying the SNPN which supports the onboarding services for the UE (101), the UE (101) may send a registration request to the AMF (107) to establish a secure connection between the UE (101) and the selected SNPN, for registering the UE (101) with the selected network (i.e., with SNPN). At S709, the AMF (107) may receive the request from the UE (101) and send a notification or response to the UE (101). Consider that the AMF (107) sends a registration rejection or failure response to the UE (101) along with a cause of rejection. As an example, the cause of rejection may include, without limitation, #74 rejection or #75 rejection. For example, #74 rejection may indicate that 5G services are not allowed for the UE (101) and #75 rejection may indicate that the UE (101) is permanently not authorized to access the selected SNPN.

At S711, after receiving a registration rejection from the AMF (107) while establishing the secure connection between the UE (101) and the selected SNPN, the UE (101) may add the selected SNPN into a list of “temporarily forbidden SNPNs” or a list of “permanently forbidden SNPNs”. For example, when the UE (101) receives the registration rejection with a cause of rejection #74, the UE (101) may add the selected SNPN into the list of “temporarily forbidden SNPNs”. Similarly, when the UE (101) receives the registration rejection with a cause of rejection #75, the UE (101) may add the selected SNPN into the list of “permanently forbidden SNPNs”. At S713, the UE (101) may enter into a limited service state. Post entering into the limited service state, the UE (101) may perform selection of another SNPN from the one or more SNPNs and may find no other suitable SNPN among the one or more SNPNs which supports onboarding services for the UE (101).

At S715, upon entering into the limited service state, the UE (101) may continue to stay camped for the limited service state and fails to proceed with onboarding. In such embodiment, though there may be PLMNs available in the vicinity of the UE (101) with which the UE (101) may easily register to proceed with onboarding, the existing techniques do not provide such mechanism for the UE (101) to use the available PLMNs for UE onboarding. Hence, the UE (101) does not make an attempt to select a PLMN among the one or more PLMNs available in the vicinity of the UE (101) and it may continue for searching the SNPN among the one or more SNPNs for onboarding S717. The present disclosure provides a solution to this problem, as discussed in the forthcoming paragraphs in connection with FIG. 7B.

FIG. 7B shows a sequence diagram 700b for onboarding the UE (101) into a network when the UE (101) is operating in the SNPN access operation mode and has entered into the limited service state, in accordance with some embodiments of the present disclosure. The operations of steps S721 to S733 are similar to the operations of steps S701 to S713 of FIG. 7A.

At S735, upon entering into the limited service state, the UE (101) may stop operating in the SNPN access operation mode and may choose to not operate in the SNPN access operation mode (i.e., the UE (101) may choose not to operate in the SNPN access operation mode). In other words, the UE (101) may deactivate the SNPN access operation mode. As a result, the UE (101) may select a PLMN among the one or more PLMNs available to the UE (101) for registration and for configuration of SNPN subscription parameters using a user plane of the selected PLMN and subsequently, the UE onboarding may be performed using the selected PLMN as indicated in step S737. The operations of onboarding the UE (101) into the selected PLMN may be same as the operations discussed in steps S627 to S631 of FIG. 6B. i.e., the UE (101) may send a registration request to the AMF (107) and in-turn may receive a notification or response indicating acceptance of the registration request. Thereafter, the UE (101) successfully registers with the selected PLMN and establishes a secure connection between the UE (101) and the selected PLMN. Subsequently, the UE (101) may obtain the UE onboarding data using the established secure connection.

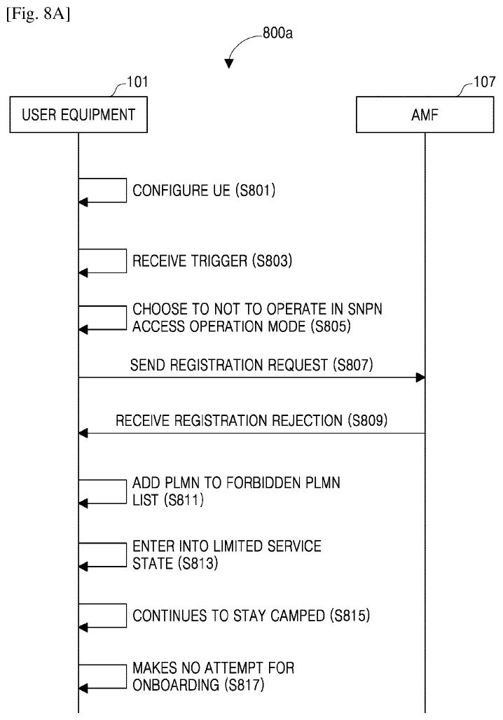

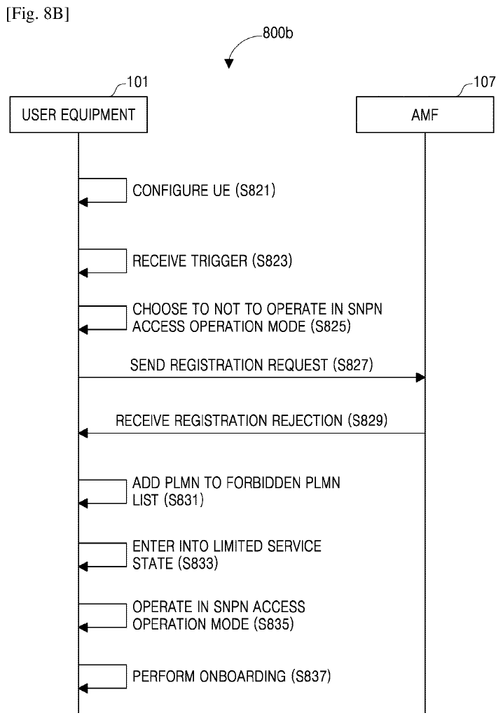

FIG. 8A shows a sequence diagram 800a of a method for onboarding a UE (101) into a core network (105) when the UE (101) is not operating in the SNPN access operation mode.

The UE (101) may choose to not operate in the SNPN access operation mode in steps S801 to S805 and may identify a suitable PLMN among one or more PLMNs available for registration of the UE (101) and for configuration of SNPN subscription parameters via a user plane of the PLMN. The process of selection of PLMN as described in steps S801 to S805 may be similar to the process described in the steps S621 to S625 of the FIG. 6B and the same is not repeated for the sake of brevity. Thereafter, at step 807, the UE (101) may send a registration request to the AMF (107) to establish a secure connection between the UE (101) and the selected PLMN.

At S809, the AMF (107) may receive the registration request from the UE (101) and send a notification or response to the UE (101). For instance, the AMF (107) may send a registration rejection or failure response to the UE (101) along with a cause of rejection. As an example, the cause of rejection may include, without limitation, #11 rejection. For example, #11 rejection may indicate that the UE (101) is permanently not authorized to access the selected PLMN.

At S811, after receiving the registration rejection from the AMF (107) while establishing the secure connection between the UE (101) and the selected PLMN, the UE (101) may add the selected PLMN into a “forbidden PLMN list”. For example, when the UE (101) receives the registration rejection with a cause of rejection #11, the UE (101) will add selected PLMN into the “forbidden PLMN list”. At S813, the UE (101) may enter into a limited service state. Post entering into the limited service state, the UE (101) may perform selection of another PLMN among the one or more PLMNs available for UE (101) registration and for configuration of SNPN subscription parameters via the user plane of the PLMN.

At S815, upon entering into the limited service state, the UE (101) continues to stay camped for the limited service state and fails to proceed with onboarding. In such embodiment, though there may be one or more SNPNs available in the vicinity of the UE (101) with which the UE (101) may easily register to proceed with onboarding, the existing techniques do not provide such mechanism for the UE (101) to use the available SNPNs for UE onboarding. Hence, at S817, the UE (101) may not make an attempt to select the SNPN among the one or more SNPNs available in the vicinity of the UE (101) and it may continue for searching the PLMN among the one or more PLMNs for the onboarding. The present disclosure provides a solution to this problem, as discussed in the forthcoming paragraphs in connection with FIG. 8B.

FIG. 8B shows a sequence diagram 800b for onboarding the UE (101) into a network when the UE (101) is not operating in the SNPN access operation mode and has entered into limited service state, in accordance with some embodiments of the present disclosure. The operations of steps S821 to S833 are similar to the operations of steps S801 to S813 of FIG. 8A and the same are not repeated for the sake of brevity.

At S835, upon entering into the limited service state, the UE (101) shall start operating in SNPN access operation mode. In other words, the UE (101) may activate the SNPN access operation mode. As a result, the UE (101) may select an SNPN among the one or more SNPNs that supports the onboarding services for the UE (101) and subsequently, the UE (101) may be onboarded into the selected SNPN by receiving onboarding data as indicated in the step S837. The operations of onboarding the UE (101) into the selected SNPN may be same as the operations discussed in steps S607 to S611 of FIG. 6A i.e., the UE (101) may send a registration request to the AMF (107) and in-turn may receive a notification or response indicating acceptance of the registration request. Thereafter, the UE (101) successfully registers with the selected SNPN and establishes a secure connection between the UE (101) and the selected SNPN. Subsequently, the UE (101) may perform onboarding into the selected SNPN by obtaining UE onboarding data using the established secure connection.

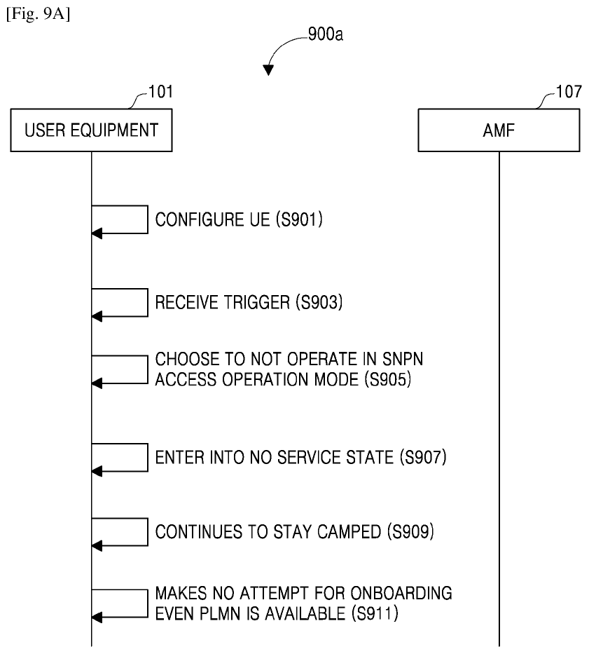

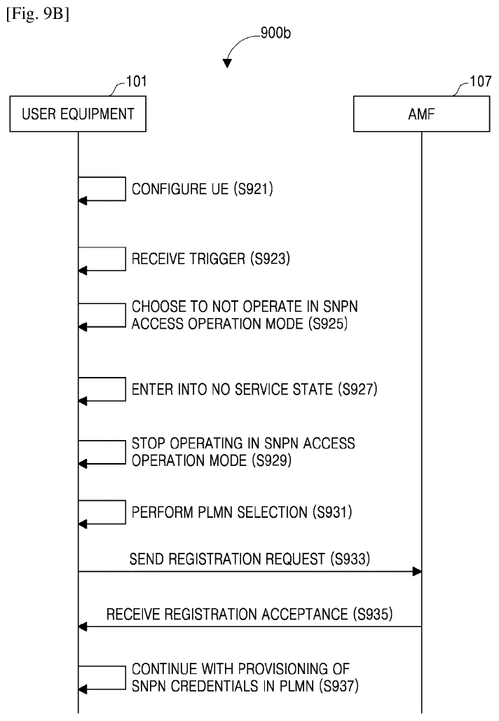

FIG. 9A shows a sequence diagram 900a of a method for onboarding a UE (101) into a core network (105) when the UE (101) is operating in the SNPN access operation mode.

In steps S901 to S903, the UE (101) may be configured with default UE credentials and PLMN credentials and may receive a trigger to perform onboarding into the network. The operations described in steps S901 to S903 may be similar to the operations described in the steps S601 to S603 of the FIG. 6A and the same are not repeated for the sake of brevity.

At S905, the UE (101) may select or choose to operate in SNPN access operation mode but does not find any suitable SNPN that supports onboarding services for the UE (101). At S907, after finding no SNPN, the UE (101) may enter into no service state. At S909, the UE (101) may continue to stay in the no service state and fail proceed with onboarding. In such embodiment, though there may be one or more PLMNs available in the vicinity of the UE (101) with which the UE (101) may easily register to proceed with onboarding, the existing techniques do not provide such mechanism for the UE (101) to use the available PLMNs for UE onboarding and hence, the UE (101) does not make an attempt to select a PLMN among the one or more PLMNs available in the vicinity of the UE (101). The present disclosure provides a solution to this problem, as discussed in the forthcoming paragraphs in connection with FIG. 9B.

FIG. 9B shows a sequence diagram 900b for onboarding the UE (101) into a network when the UE (101) is operating in the SNPN access operation mode and the UE (101) has entered into no service state, in accordance with some embodiments of the present disclosure.

Steps S921 to S927 of FIG. 9B may be similar to the steps S901 to S907 of the FIG. 9A. At S929, upon entering into the no service state, the UE (101) may stop operating in the SNPN access operation mode and may choose to not operate in the SNPN access operation mode. In other words, the UE (101) may deactivate the SNPN access operation mode. At S931, the UE (101) may perform selection of a PLMN among the one or more PLMNs available to the UE (101) for registration and for configuration of SNPN subscription parameters via user plane of the PLMN. Post selection the PLMN, at S933, the UE (101) may send a registration request to the AMF (107) associated with the selected PLMN to establish a secure connection between the UE (101) and the selected PLMN. The AMF (107) may receive the registration request and may send a notification or response (i.e., acceptance of the registration request) to the UE (101) as indicated in the S935. Thus, a secure connection is established between the UE (101) and the AMF (107) and at S937, the UE (101) may continue with the selected PLMN and obtain SNPN subscription parameters via a user pane of the selected PLMN (or the UE (101) may obtain UE onboarding data using the established secure connection.

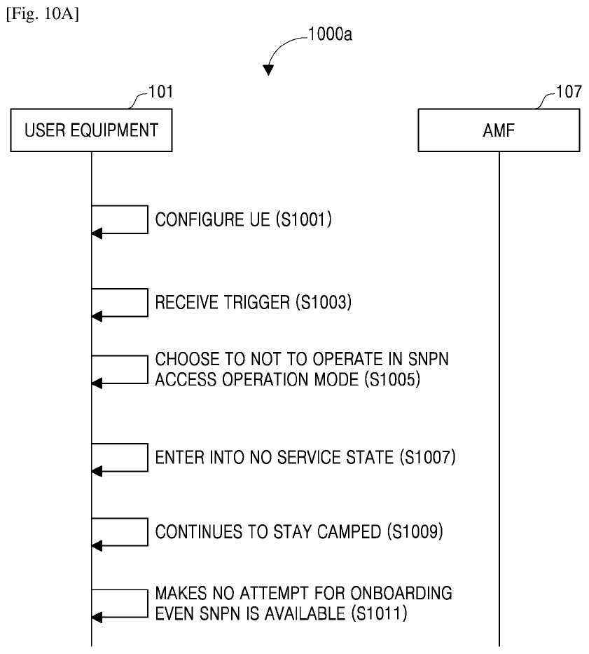

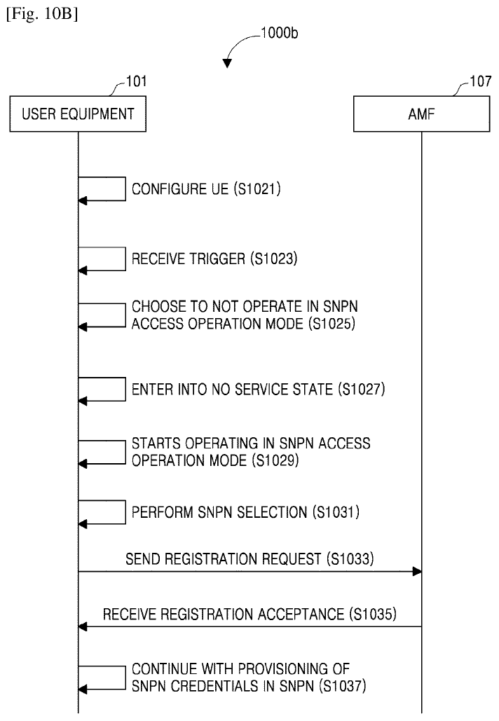

FIG. 10A shows a sequence diagram 1000a of a method for onboarding the UE (101) into the network when the UE (101) is not operating in the SNPN access operation mode.

In steps S1001 to S1003, the UE (101) may be configured with default UE credentials and PLMN credentials and may receive a trigger to perform onboarding into the network. The operations described in steps S1001 to S1003 may be similar to the operations described in the steps S601 to S603 of the FIG. 6A and the same are not repeated for the sake of brevity. At S1005, the UE (101) may select to not operate in the SNPN access operation mode but may not find any suitable PLMN for the UE (101) to perform registration and for configuration of SNPN subscription parameters via the user plane of the PLMN.

At S1007, after finding no PLMN, the UE (101) may enter into no service state. At S1009, the UE (101) may continue to stay into the no service state and fail to proceed with onboarding. In such embodiment, though there may be one or more SNPNs available in the vicinity of the UE (101) with which the UE (101) may easily register to proceed with onboarding, the existing techniques do not provide such mechanism for the UE to use the available SNPNs for UE onboarding and hence, at S1011, the UE (101) does not make an attempt to select a PLMN among the one or more PLMNs available in the vicinity of the UE (101). The present disclosure provides a solution to this problem, as discussed in the forthcoming paragraphs in connection with FIG. 10B.

FIG. 10B shows a sequence diagram 1000b for onboarding a UE (101) into a network when the UE (101) is not operating in the SNPN access operation mode and the UE has entered into no service state, in accordance with some embodiments of the present disclosure. Steps S1021 to S1027 may be similar to the steps S1001 to S1007 of FIG. 10A.

At S1029, upon entering into the no service state, the UE (101) shall start operating in the SNPN access operation mode. That is, the UE (101) may activate the SNPN access operation mode. At S1031, the UE (101) may perform selection of a SNPN among the one or more SNPNs and may select a SNPN that supports onboarding services for the UE (101). At S1033 the UE (101) may send a registration request to the AMF (107) to establish a secure connection between the UE (101) and the selected network SNPN. The AMF (107) may receive the registration request and may send a notification or response (i.e., acceptance of the registration request) to the UE (101) as indicated in the S1035. Thus, a secure connection is established between the UE (101) and the AMF (107) and at S1037, the UE (101) may continue with the selected SNPN that supports onboarding services for the UE (101) and may perform the onboarding of the UE (101) into the selected SNPN i.e., the UE (101) may obtain UE onboarding data.

In this manner, the UE (101) (which is configured with both default UE credentials and PLMN credentials and which is configured to operate in the SNPN access operation mode and not to operate in the SNPN access operation mode) may efficiently perform onboarding even if an onboarding network corresponding to a current access operation mode of the UE (101) (i.e., UE operating in SNPN access operation mode or not operating in the SNPN access operation mode) is unavailable.

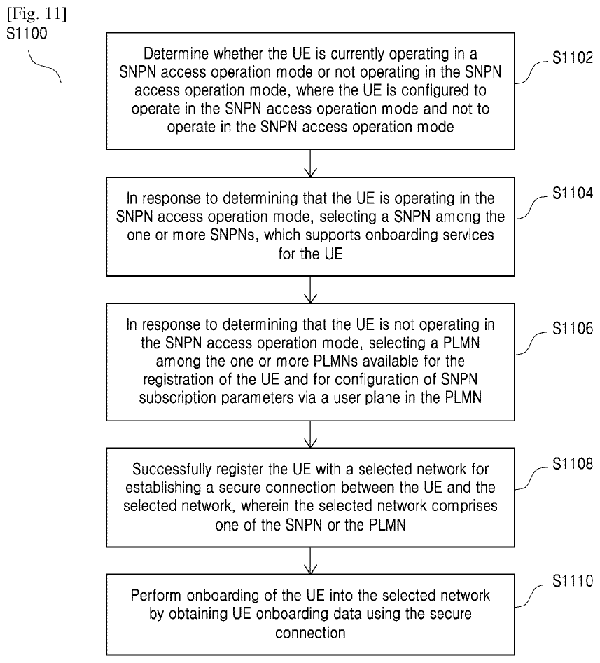

FIG. 11 shows a flowchart illustrating a method S1100 for onboarding a UE (101) into a network, in accordance with some embodiments of the present disclosure. The network may comprise one or more SNPNs and one or more PLMNs.

At block S1102, the method S1100 comprises determining whether the UE (101) is currently operating in a SNPN access operation mode or not operating in the SNPN access operation mode. The UE (101) is configured to operate in the SNPN access operation mode and not to operate in the SNPN access operation mode. The operations of block S1102 may be performed by the processor (410) (particularly, by the determining unit (412)) of FIG. 4.

At block S1104, the method S1100 comprises, in response to determining that the UE (101) is operating in the SNPN access operation mode, selecting a SNPN among the one or more SNPNs, which supports onboarding services for the UE (101). The operations of block 1104 may be performed by the processor (410) (particularly, by the selection unit (413)) of FIG. 4.

At block S1106, the method S1100 comprises, in response to determining that the UE (101) is not operating in the SNPN access operation mode, selecting a PLMN among the one or more PLMNs available for the registration of the UE (101) and for configuration of SNPN subscription parameters via a user plane in the PLMN. The operations of block 1106 may be performed by the processor (410) (particularly, by the selection unit (413)) of FIG. 4.

At block S1108, the method S1100 comprises successfully registering the UE (101) with a selected network (i.e., the SNPN as selected in block S1104 or the PLMN as selected in block S1106) for establishing a secure connection between the UE (101) and the selected network. The selected network may comprise one of the SNPN or the PLMN. In order to establish the secure connection with the network, the UE (101) may send a registration request to an AMF (107) for registering the UE (101) with the selected network, and subsequently, receive a response from the AMF (107) indicating acceptance of the registration request. The operations of block 1108 may be performed by the processor (410) (particularly, by the registering unit (414)) of FIG. 4.

At block S1110, the method S1100 comprises performing onboarding of the UE (101) into the selected network by obtaining UE onboarding data using the secure connection. The operations of block S1110 may be performed by the processor (410) (particularly, by the onboarding unit (418)) of FIG. 4. As an example, the onboarding data may comprise SNPN subscription parameters or subscription related data.

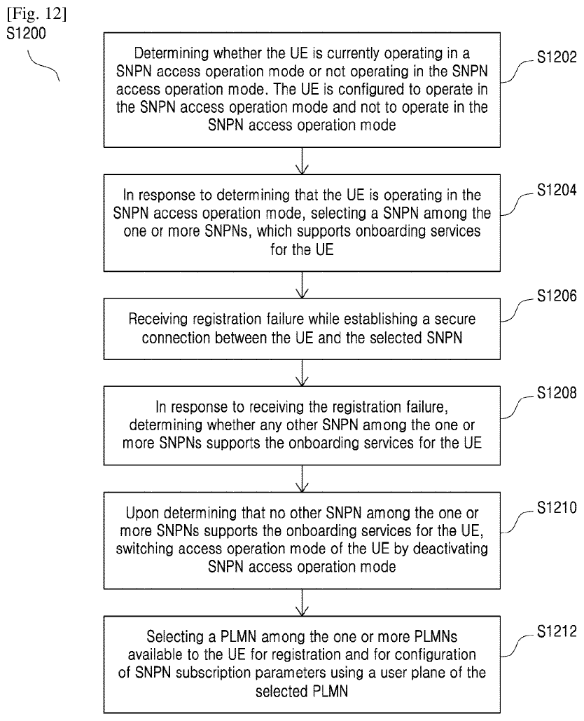

FIG. 12 shows a flowchart illustrating a method S1200 for onboarding the UE (101) into a network, in accordance with some embodiments of the present disclosure. The network may comprise one or more SNPNs and one or more PLMNs.

At block S1202, the method S1200 comprises determining whether the UE (101) is currently operating in a SNPN access operation mode or not operating in the SNPN access operation mode. The UE (101) is configured to operate in the SNPN access operation mode and not to operate in the SNPN access operation mode. The operations of block S1202 may be performed by the processor (410) (particularly, by the determining unit (412)) of FIG. 4.

At block S1204, the method S1200 comprises, in response to determining that the UE (101) is operating in the SNPN access operation mode, selecting a SNPN among the one or more SNPNs, which supports onboarding services for the UE (101). The operations of block S1204 may be performed by the processor (410) (particularly, by the selection unit (413)) of FIG. 4. At block S1206, the method 1200 comprises receiving registration failure while establishing a secure connection between the UE (101) and the selected SNPN. The operations of block S1206 may be performed by the processor (410) (particularly, by the registering unit (414)) of FIG. 4. For instance, receiving registration failure while establishing the secure connection between the UE (101) and the selected SNPN may comprise sending a registration request to AMF (107) for registering the UE (101) and receiving a response from the AMF (107) indicating rejection of the registration request. The received response may comprise information indicating cause of the registration failure. Upon receiving the response, the UE (101) may add the selected SNPN into a forbidden list, for example, a list of “temporarily forbidden SNPNs” or a list of “permanently forbidden SNPNs”.

At block S1208, the method S1200 comprises, in response to receiving the registration failure, determining whether any other SNPN among the one or more SNPNs supports the onboarding services for the UE (101). The operations of block S1208 may be performed by the processor (410) (particularly, by the determining unit (412)) of FIG. 4. At block S1210, the method comprises, upon determining that no other SNPN among the one or more SNPNs supports the onboarding services for the UE (101), switching access operation mode of the UE (101) by deactivating SNPN access operation mode. The operations of block S1210 may be performed by the processor (410) (particularly, by the switching unit (416)) of FIG. 4.

At block S1212, the method S1200 comprises, selecting a PLMN among the one or more PLMNs available to the UE (101) for registration and for configuration of SNPN subscription parameters using a user plane of the selected PLMN. The operations of block S1212 may be performed by the processor (410) (particularly, by the selection unit (413)) of FIG. 4. The configuration of SNPN subscription parameters using the user plane of the selected PLMN comprises sending a registration request to the AMF (107) for registering the UE (101) and receiving a response from the AMF (107) indicating acceptance of the registration request. Subsequently, the UE (101) may be onboarded into the network by obtaining UE onboarding data using the secure connection.

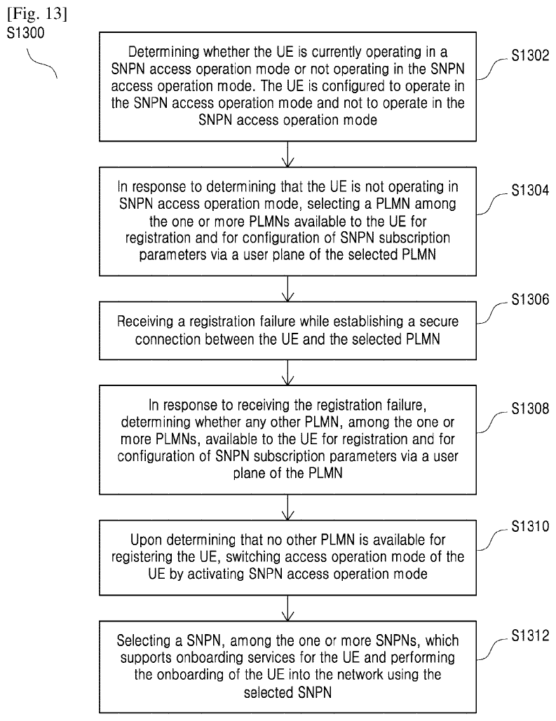

FIG. 13 shows a flowchart illustrating a method S1300 for onboarding a UE (101) into a network that comprises one or more SNPNs and one or more PLMNs, in accordance with some embodiments of the present disclosure.

At block S1302, the method S1300 comprises determining whether the UE (101) is currently operating in a SNPN access operation mode or not operating in the SNPN access operation mode. The UE (101) is configured to operate in the SNPN access operation mode and not to operate in the SNPN access operation mode. The operations of block S1302 may be performed by the processor (410) (particularly, by the determining unit (412)) of FIG. 4. At block S1304, the method S1302 comprises, in response to determining that the UE (101) is not operating in SNPN access operation mode, selecting a PLMN among the one or more PLMNs available to the UE (101) for registration and for configuration of SNPN subscription parameters via a user plane of the selected PLMN. The operations of block S1304 may be performed by the processor (410) (particularly, by the selection unit (413)) of FIG. 4.

At block S1306, the method S1300 comprises receiving a registration failure while establishing a secure connection between the UE (101) and the selected PLMN. For instance, receiving the registration failure while establishing the secure connection between the UE (101) and the selected PLMN may comprise sending a registration request to AMF (107) for registering the UE (101) and receiving a response from the AMF (107) indicating rejection of the registration request. The received response may comprise information indicating cause of the registration failure. Upon receiving the response, the UE (101) may add the selected PLMN into a “forbidden PLMN list”. The operations of block S1306 may be performed by the processor (410) (particularly, by the receiving unit (415)) of FIG. 4.

At block S1308, the method S1300 comprises, in response to receiving the registration failure, determining whether any other PLMN, among the one or more PLMNs, available to the UE (101) for registration and for configuration of SNPN subscription parameters via a user plane of the PLMN. The operations of block S1308 may be performed by the processor (410) (particularly, by the determining unit (412)) of FIG. 4. At block S1310, the method S1300 comprises, upon determining that no other PLMN is available for registering the UE (101), switching access operation mode of the UE (101) by activating SNPN access operation mode. The operations of block S1310 may be performed by the processor (410) (particularly, by the switching unit (416)) of FIG. 4.

At block S1312, the method S1300 comprises, selecting a SNPN, among the one or more SNPNs, which supports onboarding services for the UE (101) and performing the onboarding of the UE (101) into the network using the selected SNPN. As an example, the performing onboarding of the UE (101) into the network may comprise sending a registration request to the AMF (107) for registering the UE (101) with the selected SNPN and receiving a response from the AMF (107) indicting acceptance of the registration request. The operations of block S1312 may be performed by the processor (410) (particularly, by the onboarding unit (418)) of FIG. 4.

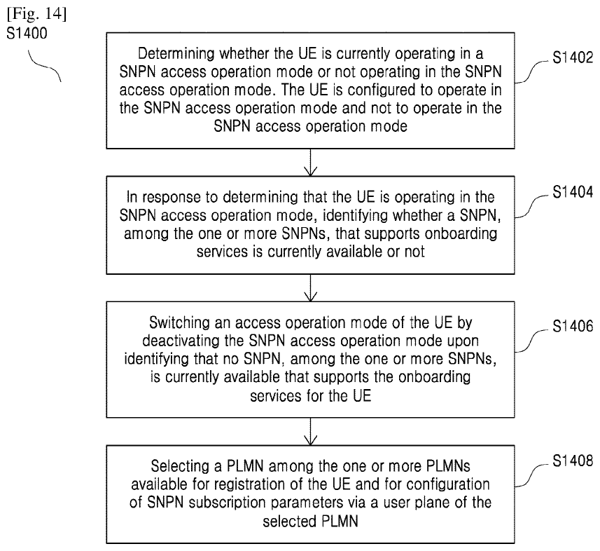

FIG. 14 shows a flowchart illustrating a method S1400 for onboarding a UE (101) into a network that comprises one or more SNPNs and one or more PLMNs, in accordance with some embodiments of the present disclosure.

At block S1402, the method S1400 comprises determining whether the UE (101) is currently operating in a SNPN access operation mode or not operating in the SNPN access operation mode. The UE (101) is configured to operate in the SNPN access operation mode and not to operate in the SNPN access operation mode. The operations of block S1402 may be performed by the processor (410) (particularly, by the determining unit (412)) of FIG. 4. At block S1404, the method S1400 comprises, in response to determining that the UE (101) is operating in the SNPN access operation mode, identifying whether a SNPN, among the one or more SNPNs, that supports onboarding services is currently available or not. The operations of block S1404 may be performed by the processor (410) (particularly, by the identifying unit (417)) of FIG. 4.

At block S1406, the method S1400 comprises, switching an access operation mode of the UE (101) by deactivating the SNPN access operation mode upon identifying that no SNPN, among the one or more SNPNs, is currently available that supports the onboarding services for the UE (101). The operations of block S1406 may be performed by the processor (410) (particularly, by the switching unit (416)) of FIG. 4.

At block S1408, the method S1400 comprises, selecting a PLMN among the one or more PLMNs available for registration of the UE (101) and for configuration of SNPN subscription parameters via a user plane of the selected PLMN. The operations of block S1408 may be performed by the processor (410) (particularly, by the selection unit (413)) of FIG. 4.

In one embodiment, configuring of SNPN subscription parameters using the user plane of the selected PLMN comprises establishing a secure connection between the UE (101) and the selected PLMN by sending a registration request to an AMF (107) for registering the UE (101) with the selected PLMN, and receiving a response from the AMF (107) indicating acceptance of the registration request. The method S1400 may further comprise performing onboarding of the UE (101) into the network by obtaining UE onboarding data using the secure connection, where the UE onboarding data comprises SNPN subscription related data or subscription parameters.

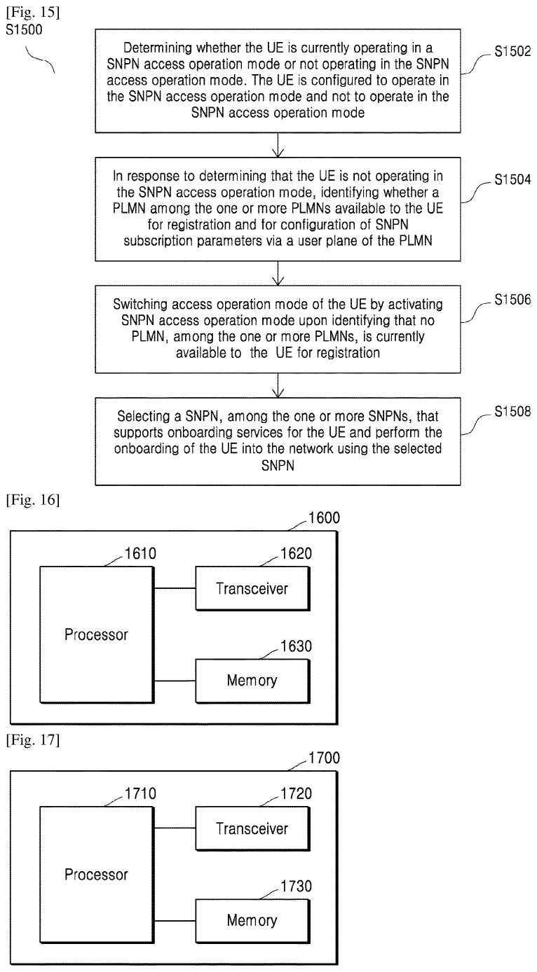

FIG. 15 shows a flowchart illustrating a method S1500 for onboarding a UE (101) into a network that comprises one or more SNPNs and one or more PLMNs, in accordance with some embodiments of the present disclosure.

At block S1502, the method S1500 comprises determining whether the UE (101) is currently operating in a SNPN access operation mode or not operating in the SNPN access operation mode. The UE (101) is configured to operate in the SNPN access operation mode and not to operate in the SNPN access operation mode. The operations of block S1502 may be performed by the processor (410) (particularly, by the determining unit (412)) of FIG. 4. At block S1504, the method comprises, in response to determining that the UE (101) is not operating in the SNPN access operation mode, identifying whether a PLMN among the one or more PLMNs available to the UE (101) for registration and for configuration of SNPN subscription parameters via a user plane of the PLMN. The operations of block S1504 may be performed by the processor (410) (particularly, by the identifying unit (417)) of FIG. 4.

At block S1506, the method S1500 comprises, switching access operation mode of the UE (101) by activating SNPN access operation mode upon identifying that no PLMN, among the one or more PLMNs, is currently available to the UE (101) for registration. The operations of block S1506 may be performed by the processor (410) (particularly, by the switching unit (416)) of FIG. 4.

At block S1508, the method S1500 comprises, selecting a SNPN, among the one or more SNPNs, that supports onboarding services for the UE (101) and perform the onboarding of the UE (101) into the network using the selected SNPN. The operations of block S1508 may be performed by the processor (410) (particularly, by the selection unit (413)) of FIG. 4.

In one non-limiting embodiment, wherein performing the onboarding of the UE (101) into the network based on the selected SNPN comprises establishing a secure connection between the UE (101) and the selected SNPN, where establishing the secure connection comprises sending a registration request to an AMF (107) for registering the UE (101) with the selected SNPN and receiving a response from the AMF (107) indicating acceptance of the registration request. In one embodiment, the method S1500 further comprises performing onboarding of the UE (101) into the network by obtaining UE onboarding data using the secure connection, where the UE onboarding data comprises SNPN subscription related data or subscription parameters.

The methods S500, S1100 to S1500 may comprise one or more steps. The methods S500, S1100 to S1500 may be described in the general context of computer executable instructions. Generally, computer executable instructions can include routines, programs, objects, components, data structures, procedures, modules, and functions, which perform particular functions or implement particular abstract data types.

The order in which the methods S500, S1100 to S1500 are described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof. The various operations of the methods S500, S1100 to S1500 may be performed by an apparatus. The apparatus may be the UE (101) or may comprise some components of the UE (101) e.g., at least the processor (410) and the memory (430).

The present disclosure provides efficient techniques for onboarding a UE into a network. In the present disclosure, when a network (for example, SNPN/PLMN) associated with a current operation mode of the UE is in limited state or is unavailable, the UE need not to wait for the network availability, instead the UE may automatically switch its access operation mode and may select the available network (for example, PLMN/SNPN) for onboarding. Thus, the present disclosure provides flexibility of switching the operation access modes for onboarding of the UE. This helps in efficient utilization of computing resources of the UE, providing seamless services to the UE, and also helps in optimizing the battery usage by the UE.

The various actions, acts, blocks, steps, or the like in the flow charts (S500, S1100 to S1500) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

In accordance with an embodiment of the disclosure, a method for onboarding a User Equipment (UE) (101) into a core network (105) which comprises one or more Standalone Non-Public Networks (SNPNs) and one or more Public Land Mobile Networks (PLMNs) is provided. The method may comprise: determining whether the UE (101) is currently operating in a SNPN access operation mode or not operating in the SNPN access operation mode, wherein the UE (101) is configured to operate in the SNPN access operation mode and not to operate in the SNPN access operation mode; in response to determining that the UE (101) is operating in the SNPN access operation mode, selecting a SNPN, among the one or more SNPNs, which supports onboarding services for the UE (101); and in response to determining that the UE (101) is not operating in the SNPN access operation mode, selecting a PLMN among the one or more PLMNs available for registration of the UE (101) and for configuration of SNPN subscription parameters via a user plane in the PLMN; successfully registering the UE (101) with a selected network for establishing a secure connection between the UE (101) and the selected network, wherein the selected network comprises one of the SNPN or the PLMN; and performing onboarding of the UE (101) into the selected network by obtaining UE onboarding data using the secure connection.

In an embodiment, wherein successfully registering the UE (101) with the selected network for establishing the secure connection comprises: sending a registration request to an Access and Mobility Management Function (AMF) (107) for registering the UE (101) with the selected network; and receiving a response from the AMF (107) indicating acceptance of the registration request.

In an embodiment, wherein the UE (101) onboarding data comprises SNPN subscription parameters or subscription related data.

In accordance with an embodiment of the disclosure, a method for onboarding a User Equipment (UE) (101) into a core network (105) which comprises one or more Standalone Non-Public Networks (SNPNs) and one or more Public Land Mobile Networks (PLMNs) is provided. The method may comprise: determining whether the UE (101) is currently operating in a SNPN access operation mode or not operating in the SNPN access operation mode, wherein the UE (101) is configured to operate in the SNPN access operation mode and to not operate in the SNPN access operation mode; in response to determining that the UE (101) is operating in the SNPN access operation mode, selecting a SNPN, among the one or more SNPNs, which supports onboarding services for the UE (101); receiving a registration failure while establishing a secure connection between the UE (101) and the selected SNPN; in response to receiving the registration failure, determining whether any other SNPN among the one or more SNPNs supports the onboarding of the UE (101); upon determining that no other SNPN among the one or more SNPNs supports the onboarding of the UE (101), switching access operation mode of the UE (101) by deactivating the SNPN access operation mode; and selecting a PLMN among the one or more PLMNs available to the UE (101) for registration and for configuration of SNPN subscription parameters using a user plane of the selected PLMN.

In an embodiment, the method may further comprise: adding the selected SNPN into temporarily forbidden SNPNs or permanently forbidden SNPNs upon receiving the registration failure while establishing the secure connection between the UE (101) and the selected SNPN.

In an embodiment, wherein receiving the registration failure while establishing the secure connection between the UE (101) and the selected SNPN comprises: sending a registration request to an Access and Mobility Management Function (AMF) for registering the UE (101) with the selected SNPN; and receiving a response from the AMF (107) indicating rejection of the registration request, wherein the received response comprises information indicating cause of the registration failure.

In an embodiment, wherein configuring of SNPN subscription parameters using the user plane of the selected PLMN comprises establishing a secure connection between the UE (101) and the PLMN by: sending a registration request to an Access and Mobility Management Function (AMF) (107) for registering the UE (101) with the selected PLMN; and receiving a response from the AMF (107) indicating acceptance of the registration request.

In an embodiment, the method may further comprise: performing onboarding of the UE (101) into the network (105) by obtaining UE onboarding data using the secure connection, wherein the UE onboarding data comprises subscription related data or the subscription parameters.

In an embodiment, a method for onboarding a User Equipment (UE) (101) into a core network (105) which comprises one or more Standalone Non-Public Networks (SNPNs) and one or more Public Land Mobile Networks (PLMNs) is provided. The method (1000) may comprise: determining whether the UE (101) is currently operating in a SNPN access operation mode or not operating in the SNPN access operation mode, wherein the UE is configured to operate in the SNPN access operation mode and not to operate in the SNPN access operation mode; in response to determining that the UE (101) is not operating in the SNPN access operation mode, selecting a PLMN among the one or more PLMNs available to the UE (101) for registration and for configuration of SNPN subscription parameters via a user plane of the selected PLMN; receiving a registration failure while establishing a secure connection between the UE (101) and the selected PLMN; in response to receiving the registration failure, determining whether any other PLMN among the one or more PLMNs is available to the UE (101) for registration and for configuration of SNPN subscription parameters via the user plane of the PLMN; upon determining that no other PLMN is available for registration of the UE (101), switching access operation mode of the UE (101) by activating the SNPN access operation mode; and selecting a SNPN, among the one or more SNPNs, which supports the onboarding services for the UE (101) and performing the onboarding of the UE (101) into the network (105) using the selected SNPN.

In an embodiment, the method may further comprise: adding the selected PLMN into a forbidden PLMN list upon receiving the registration failure while establishing the secure connection between the UE (101) and the selected PLMN.

In an embodiment, wherein receiving the registration failure while establishing the secure connection between the UE (101) and the selected PLMN comprises: sending a registration request to an Access and Mobility Management Function (AMF) for registering the UE (101) with the selected PLMN; and receiving a response from the AMF (107) indicating rejection of the registration request, wherein the received response comprises information indicating cause of the registration failure.

In an embodiment, wherein performing the onboarding of the UE (101) into the network using the selected SNPN comprises establishing a secure connection between the UE (101) and the SNPN by: sending a registration request to an Access and Mobility Management Function (AMF) (107) for registering the UE (101) with the selected SNPN; and receiving a response from the AMF (107) indicating acceptance of the registration request.

In an embodiment, the method may further comprise: performing onboarding of the UE (101) into the network (105) by obtaining UE onboarding data using the secure connection, wherein the UE onboarding data comprises SNPN subscription parameters or subscription related data.

In accordance with an embodiment of the disclosure, a method for onboarding a User Equipment (UE) (101) into a core network (105) which comprises one or more Standalone Non-Public Networks (SNPNs) and one or more Public Land Mobile Networks (PLMNs) is provided. The method may comprise: determining whether the UE (101) is currently operating in a SNPN access operation mode or not operating in the SNPN access operation mode, wherein the UE (101) is configured to operate in the SNPN access operation mode and to not operate in the SNPN access operation mode; in response to determining that the UE (101) is operating in the SNPN access operation mode, identifying whether a SNPN, among the one or more SNPNs, that supports onboarding services is currently available or not; switching an access operation mode of the UE (101) by deactivating the SNPN access operation mode upon identifying that no SNPN, among the one or more SNPNs, is currently available that supports the onboarding services for the UE (101); and selecting a PLMN among the one or more PLMNs available for registration of the UE (101) and for configuration of SNPN subscription parameters using a user plane of the selected PLMN.

In an embodiment, wherein configuring of SNPN subscription parameters using the user plane of the selected PLMN comprises establishing a secure connection between the UE (101) and the selected PLMN by: sending a registration request to an Access and Mobility Management Function (AMF) (107) for registering the UE (101) with the selected PLMN; and receiving a response from the AMF (107) indicating acceptance of the registration request.

In an embodiment, the method may further comprise: performing onboarding of the UE (101) into the network (105) by obtaining UE onboarding data using the secure connection, wherein the UE onboarding data comprises SNPN subscription related data or subscription parameters.

In accordance with an embodiment of the disclosure, a method for onboarding a User Equipment (UE) (101) into a network which comprises one or more Standalone Non-Public Networks (SNPNs) and one or more Public Land Mobile Networks (PLMNs) is provided. The method may comprise: determining whether the UE (101) is currently operating in a SNPN access operation mode or not operating in the SNPN access operation mode, wherein the UE is configured to operate in the SNPN access operation mode and not to operate in the SNPN access operation mode; in response to determining that the UE (101) is not operating in the SNPN access operation mode, identifying whether a PLMN among the one or more PLMNs is available to the UE (101) for registration and for configuration of SNPN subscription parameters via a user plane of the PLMN; switching an access operation mode of the UE (101) by activating the SNPN access operation mode upon identifying that no PLMN, among the one or more PLMNs, is currently available for registration of the UE (101) and for configuration of SNPN subscription parameters via user plane of the PLMN; and selecting a SNPN, among the one or more SNPNs, which supports the onboarding services for the UE and performing the onboarding of the UE into the network (105) using the selected SNPN.

In an embodiment, wherein performing the onboarding of the UE (101) into the core network (105) based on the selected SNPN comprises establishing a secure connection between the UE (101) and the selected SNPN by: sending a registration request to an Access and Mobility Management Function (AMF) (107) for registering the UE (101) with the selected SNPN; and receiving a response from the AMF (107) indicating acceptance of the registration request.

In an embodiment, the method may further comprise: performing onboarding of the UE (101) into the network (105) by obtaining UE onboarding data using the secure connection, wherein the UE onboarding data comprises SNPN subscription related data or subscription parameters.

In accordance with an embodiment of the disclosure, an apparatus (101) for onboarding a User Equipment (UE) (101) into a network (105) which comprises one or more Standalone Non-public Networks (SNPNs) and one or more Public Land Mobile Networks (PLMNs) is provided. The apparatus (101) may comprise: a memory (430); and a processor (410) communicatively coupled to the memory (430) and configured to: determine whether the UE (101) is currently operating in a SNPN access operation mode or not operating in the SNPN access operation mode, wherein the UE (101) is configured to operate in the SNPN access operation mode and to not operate in the SNPN access operation mode; in response to determining that the UE (101) is operating in the SNPN access operation mode, select a SNPN, among the one or more SNPNs, which supports onboarding services for the UE (101); in response to determining that the UE (101) is not operating in the SNPN access operation mode, select a PLMN among the one or more PLMNs configuration of SNPN subscription parameters via a user plane in the PLMN; successfully register the UE (101) with a selected network for establishing a secure connection between the UE (101) and the selected network, wherein the selected network comprises one of the SNPN or the PLMN; and perform onboarding of the UE (101) into the selected network by obtaining UE onboarding data using the secure connection.

In accordance with an embodiment of the disclosure, an apparatus (101) for onboarding a User Equipment (UE) (101) into a network (105) which comprises one or more Standalone Non-public Networks (SNPNs) and one or more Public Land Mobile Networks (PLMNs) is provided. The apparatus comprising: a memory (430); and a processor (410) communicatively coupled to the memory (430) and configured to: determine whether the UE (101) is currently operating in a SNPN access operation mode or not operating in the SNPN access operation mode, wherein the UE (101) is configured to operate in the SNPN access operation and not to operate in the SNPN access operation mode; in response to determining that the UE (101) is operating in the SNPN access operation mode, select a SNPN, among the one or more SNPNs, which supports onboarding services for the UE (101); receive registration failure while establishing a secure connection between the UE (101) and the selected SNPN; in response to receiving the registration failure, determine whether any other SNPN among the one or more SNPNs supports the onboarding services for the UE (101); upon determining that no other SNPN among the one or more SNPNs supports the onboarding services for the UE (101), switch access operation mode of the UE (101) by deactivating the SNPN access operation mode; and select a PLMN among the one or more PLMNs, available to the UE (101) for registration and for configuration of SNPN subscription parameters using user plane of the selected PLMN.

In accordance with an embodiment of the disclosure, an apparatus (101) for onboarding a User Equipment (UE) (101) into a network (105) which comprises one or more Standalone Non-public Networks (SNPNs) and one or more Public Land Mobile Networks (PLMNs) is provided. The apparatus (101) may comprise: a memory (430); and a processor (410) communicatively coupled to the memory (430) and configured to: determine whether the UE (101) is currently operating in a SNPN access operation mode or not operating in the SNPN access operation mode, wherein the UE is configured to operate in the SNPN access operation mode and not to operate in the SNPN access operation mode; in response to determining that the UE (101) is not operating in the SNPN access operation mode, select a PLMN among the one or more PLMNs available to the UE (101) for registration and for configuration of SNPN subscription parameters via a user plane of the selected PLMN; receive registration failure while establishing a secure connection between the UE (101) and the selected PLMN; in response to receiving the registration failure, determine whether any other PLMN among the one or more PLMNs is available to the UE (101) for registration and for configuration of the SNPN subscription parameters via a user plane of the PLMN; upon determining that no other PLMN is available for registration of the UE (101), switch access operation mode of the UE (101) by activating the SNPN access operation mode; and select a SNPN, among the one or more SNPNs, which supports onboarding services of the UE (101) and perform the onboarding of the UE (101) into the network using the selected SNPN.

In accordance with an embodiment of the disclosure, an apparatus (101) for onboarding a User Equipment (UE) (101) into a network (105) which comprises one or more Standalone Non-public Networks (SNPNs) and one or more Public Land Mobile Networks (PLMNs) is provided. The apparatus (101) may comprise: a memory (430); and a processor (410) communicatively coupled to the memory (430) and configured to: determine whether the UE (101) is currently operating in a SNPN access operation mode or not operating in the SNPN access operation mode, wherein the UE (101) is configured to operate in the SNPN access operation mode and not to operate in the SNPN access operation mode; in response to determining that the UE (101) is operating in the SNPN access operation mode, identify whether a SNPN, among the one or more SNPNs, that supports onboarding services is currently available or not; switch access operation mode of the UE (101) by deactivating SNPN access operation mode upon identifying that no SNPN, among the one or more SNPNs, is currently available that supports the onboarding services for UE (101); and select a PLMN among the one or more PLMNs available for registration of the UE (101) and for configuration of SNPN subscription parameters using a user plane of the selected PLMN.

In accordance with an embodiment of the disclosure, an apparatus (101) for onboarding a User Equipment (UE) (101) into a network which comprises one or more Standalone Non-public Networks (SNPNs) and one or more Public Land Mobile Networks (PLMNs) is provided. The apparatus (101) may comprise: a memory (430); and a processor (410) communicatively coupled to the memory (430) and configured to: determine whether the UE (101) is currently operating in a SNPN access operation mode or not operating in the SNPN access operation mode, wherein the UE (101) is configured to operate in the SNPN access operation mode and not to operate in the SNPN access operation mode; in response to determining that the UE (101) is not operating in the SNPN access operation mode, identify whether a PLMN, among the one or more PLMNs, is available to the UE (101) for registration and for configuration of SNPN subscription parameters via a user plane of the PLMN; switch access operation mode of the UE (101) by activating the SNPN access operation mode upon identifying that no PLMN, among the one or more PLMNS, is currently available for registration of the UE (101) and for configuration of the SNPN subscription parameters via the user plane of the PLMN; and select a SNPN, among the one or more SNPNs which supports the onboarding services of the UE (101) and perform onboarding of the UE (101) into the network (105) using the selected SNPN.

In accordance with an embodiment of the disclosure, a method performed by a user equipment (UE) in a wireless communication system is provided. The method may comprise: selecting a stand-alone non-public network (SNPN); performing a registration on the selected SNPN; in case that the registration is rejected, adding the SNPN to a list of forbidden SNPNs; and in case that the SNPN is removed from the list of forbidden SNPNs and the UE is in a limited service state, performing an SNPN selection.

In an embodiment, wherein the SNPN is removed from the list of forbidden SNPNs due to an expiry of a timer T3245.

In an embodiment, wherein the SNPN is removed from the list of forbidden SNPNs due to an expiry of a UE implementation specific timer.

In an embodiment, wherein the UE implementation specific timer is not shorter than 60 minutes.

In an embodiment, wherein the list of forbidden SNPNs includes a list of temporarily forbidden SNPNs.

In an embodiment, wherein the list of forbidden SNPNs includes a list of a permanently forbidden SNPNs.

In an embodiment, wherein the UE is in an SNPN access operation mode.

In accordance with an embodiment of the disclosure, a user equipment (UE) in a wireless communication system is provided. The UE may comprise: a transceiver; and at least one processor coupled with the transceiver and configured to: select a stand-alone non-public network (SNPN); perform a registration on the selected SNPN; in case that the registration is rejected, add the SNPN to a list of forbidden SNPNs; and in case that the SNPN is removed from the list of forbidden SNPNs and the UE is in a limited service state, perform an SNPN selection.

In an embodiment, wherein the SNPN is removed from the list of forbidden SNPNs due to an expiry of a timer T3245.

In an embodiment, wherein the SNPN is removed from the list of forbidden SNPNs due to an expiry of a UE implementation specific timer.

In an embodiment, wherein the UE implementation specific timer is not shorter than 60 minutes.

In an embodiment, wherein the list of forbidden SNPNs includes a list of temporarily forbidden SNPNs.

In an embodiment, wherein the list of forbidden SNPNs includes a list of a permanently forbidden SNPNs.

FIG. 16 is a diagram illustrating a UE 1600 according to an embodiment of the present disclosure.

Referring to the FIG. 16, the UE 1600 may include a processor 1610, a transceiver 1620, and a memory 1630. However, all of the illustrated components are not essential. The UE 1600 may be implemented by more or less components than those illustrated in the FIG. 16. In addition, the processor 1610, and the transceiver 1620, and the memory 1630 may be implemented as a single chip according to another embodiment.

The aforementioned components will now be described in detail.

The processor 1610 may include one or more processors or other processing devices that control the proposed function, process, and/or method. Operation of the UE 1600 may be implemented by the processor 1610.

The transceiver 1620 may be connected to the processor 1610 and transmit and/or receive a signal. In addition, the transceiver 1620 may receive the signal through a wireless channel and output the signal to the processor 1610. The transceiver 1620 may transmit the signal output from the processor 1610 through the wireless channel.

The memory 1630 may store the control information or the data included in a signal obtained by the UE 1600. The memory 1630 may be connected to the processor 1610 and store at least one instruction, or a protocol, or a parameter for the proposed function, process, and/or method. The memory 1630 may include read-only memory (ROM) and/or random access memory (RAM) and/or hard disk and/or CD-ROM and/ or DVD and/or other storage devices.

FIG. 17 is a diagram illustrating a base station 400 according to an embodiment of the present disclosure.

Referring to the FIG. 17, the base station 1700 may include a processor 1710, a transceiver 1720 and a memory 1730. However, all of the illustrated components are not essential. The base station 1700 may be implemented by more or less components than those illustrated in FIG. 17. In addition, the processor 1710, and the transceiver 1720, and the memory 1730 may be implemented as a single chip according to another embodiment. The aforementioned components will now be described in detail.

The processor 1710 may include one or more processors or other processing devices that control the proposed function, process, and/or method. Operation of the base station 1700 may be implemented by the processor 1710.

The transceiver 1720 may be connected to the processor 1710 and transmit and/or receive a signal. The signal may include control information and data. In addition, the transceiver 1720 may receive the signal through a wireless channel and output the signal to the processor 1710. The transceiver 1720 may transmit a signal output from the processor 1710 through the wireless channel.

The memory 1730 may store the control information or the data included in a signal obtained by the base station 1700. The memory 1730 may be connected to the processor 1710 and store at least one instruction or a protocol or a parameter for the proposed function, process, and/or method. The memory 1730 may include read-only memory (ROM) and/or random access memory (RAM) and/or hard disk and/or CD-ROM and/or DVD and/or other storage devices.

Methods according to the claims of the disclosure or the various embodiments of the disclosure described in the specification may be implemented in hardware, software, or a combination of hardware and software.

When implemented in software, a computer-readable storage medium storing one or more programs (software modules) may be provided. One or more programs stored in the computer-readable storage medium are configured for execution by one or more processors in an electronic device. The one or more programs may include instructions that cause the electronic device to perform the methods in accordance with the claims of the disclosure or the various embodiments of the disclosure described in the specification.

The programs (software modules, software) may be stored in a random access memory (RAM), a non-volatile memory including a flash memory, a read only memory (ROM), an electrically erasable programmable ROM (EEPROM), a magnetic disc storage device, a compact disc-ROM (CD-ROM), a digital versatile disc (DVD) or other types of optical storage device, and/or a magnetic cassette. Alternatively, the programs may be stored in a memory including a combination of some or all of them. There may be a plurality of memories.

The program may also be stored in an attachable storage device that may be accessed over a communication network including the Internet, an intranet, a Local Area Network (LAN), a wide area network (WAN), or a storage area network (SAN), or a combination thereof. The storage device may be connected to an apparatus performing the various embodiments of the disclosure through an external port. In addition, a separate storage device in the communication network may be connected to the apparatus performing the various embodiments of the disclosure.

In the various embodiments of the present disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

While the disclosure has been shown and described with reference to various embodiments thereof, it will be understood by those skilled in the art that various changes in form and details may be made therein without departing from the spirit and scope of the disclosure as defined by the appended claims and their equivalents.

1. A method performed by a user equipment (UE) in a wireless communication system, the method comprising:
selecting a stand-alone non-public network (SNPN);
performing a registration on the selected SNPN;
in case that the registration is rejected, adding the SNPN to a list of forbidden SNPNs; and
in case that the SNPN is removed from the list of forbidden SNPNs and the UE is in a limited service state, performing an SNPN selection.

2. The method of claim 1, wherein the SNPN is removed from the list of forbidden SNPNs due to an expiry of a timer T3245.

3. The method of claim 1, wherein the SNPN is removed from the list of forbidden SNPNs due to an expiry of a UE implementation specific timer.

4. The method of claim 3, wherein the UE implementation specific timer is not shorter than 60 minutes.

5. The method of claim 1, wherein the list of forbidden SNPNs includes a list of temporarily forbidden SNPNs.

6. The method of claim 1, wherein the list of forbidden SNPNs includes a list of a permanently forbidden SNPNs.

7. The method of claim 1, wherein the UE is in an SNPN access operation mode.

8. A user equipment (UE) in a wireless communication system, the UE comprising:
a transceiver; and
at least one processor coupled with the transceiver and configured to:
select a stand-alone non-public network (SNPN);
perform a registration on the selected SNPN;
in case that the registration is rejected, add the SNPN to a list of forbidden SNPNs; and
in case that the SNPN is removed from the list of forbidden SNPNs and the UE is in a limited service state, perform an SNPN selection.

9. The UE of claim 8, wherein the SNPN is removed from the list of forbidden SNPNs due to an expiry of a timer T3245.

10. The UE of claim 8, wherein the SNPN is removed from the list of forbidden SNPNs due to an expiry of a UE implementation specific timer.

11. The UE of claim 10, wherein the UE implementation specific timer is not shorter than 60 minutes.

12. The UE of claim 8, wherein the list of forbidden SNPNs includes a list of temporarily forbidden SNPNs.

13. The UE of claim 8, wherein the list of forbidden SNPNs includes a list of a permanently forbidden SNPNs.

14. The UE of claim 8, wherein the UE is in an SNPN access operation mode.
